(19) United States
(12) Patent Application Publication
(10) Pub. No.: US 2025/0078047 A1
(43) Pub. Date: Mar. 6, 2025

(54) METHOD OF PROCESSING PAYMENTS AND ISSUING ELECTRONIC RECEIPTS OVER NEAR FIELD COMMUNICATION

(71) Applicant: PI-XCELS CO., LTD., Seongnam-si (KR)

(72) Inventor: Daniel Ching Luen LIM, Singapore (SG)

(21) Appl. No.: 18/725,798

(22) PCT Filed: Jan. 10, 2023
(86) PCT No.: PCT/IB2023/050226

§ 371 Date: Jun. 30, 2024

Related U.S. Application Data
(60) Provisional application No. 63/477,690, filed on Dec. 29, 2022.

(30) Foreign Application Priority Data
Jan. 11, 2022 (KR) 10-2022-0003963
Mar. 25, 2022 (KR) 10-2022-0037255
Sep. 29, 2022 (WO) PCT/KR2022/014622

(51) Int. Cl. G06Q 20/04; G06F 16/955; G06Q 20/32; G06Q 20/38; G06Q 20/40

(52) U.S. Cl. CPC G06Q 20/047; G06F 16/955; G06Q 20/3278; G06Q 20/3827; G06Q 20/389; G06Q 20/4012; G06Q 2220/00

(57) ABSTRACT

Computing devices and methods for issuing an electronic receipt. Transaction information may be received and sent to a transfer rail. A unique transaction identifier can be generated using a hash function applied to the transaction information, and/or using the date information and time information, and/or a unique device identifier. A uniform resource locator (URL) can be generated based on the unique transaction identifier and/or at least some of a plurality of receipt elements. A confirmation of a successful completion of a transfer card transaction may be received from the transfer rail. The URL can be sent to an NFC tag controller.

### CROSS-REFERENCE TO RELATED APPLICATION(S)

This application claims the benefit of priority to U.S. Provisional Patent Application No. 63/477,690, entitled “METHOD OF PROCESSING PAYMENTS AND ISSUING ELECTRONIC RECEIPTS OVER NEAR FIELD COMMUNICATION,” filed on Dec. 29, 2022, PCT Patent Application No. PCT/KR2022/014622 entitled “METHOD OF ISSUING ELECTRONIC RECEIPTS”, filed on Sep. 29, 2022, Korean Patent Application No. 10-2022-0037255 entitled “METHOD OF ISSUING ELECTRONIC RECEIPTS”, filed Mar. 25, 2022, and Korean Patent Application No. 10-2022-0003963 entitled “METHOD OF ISSUING ELECTRONIC RECEIPTS”, filed Jan. 11, 2022, all the contents of which are hereby incorporated by reference herein in their entirety. This application is also a continuation-in-part of PCT Patent Application No. PCT/KR2022/014622 entitled “METHOD OF ISSUING ELECTRONIC RECEIPTS”, filed on Sep. 29, 2022, which claims the benefit of priority to Korean Patent Application No. 10-2022-0037255 entitled “METHOD OF ISSUING ELECTRONIC RECEIPTS”, filed Mar. 25, 2022, and Korean Patent Application No. 10-2022-0003963 entitled “METHOD OF ISSUING ELECTRONIC RECEIPTS”, filed Jan. 11, 2022.

### TECHNICAL FIELD

Example embodiments relate to the provision of electronic receipts (e-receipts or receipts), for example, the provision of electronic receipts at the time of sale and using Near Field Communication (NFC) technology.

### BACKGROUND

When a consumer completes a transaction associated with the purchase of goods or use of a service, the consumer receives a receipt. In conventional systems, a point of sale (POS) terminal may promptly issue a paper receipt and may provide the consumer with an e-receipt at a future time. Drawbacks to paper receipts include the risk of leakage of personal information, challenges in efficient receipt management, and the cost of generating printed receipts. E-receipts are generally preferred, as they provide surety of personal information, are easier to retain and manage, are less expensive to produce, and are environmentally friendly. Efficient computing devices and methods for the timely provision of e-receipts are desired. In conventional systems, the timely provision of an e-receipt may require a user device to have been “prepared” to display an e-receipt. For example, a transactee may be required to pre-install an application, to activate a user device camera to scan a QR code, and/or to exchange an email address or a phone number with an e-receipt provider, etc. These conditions create obstacles for the timely issuance of e-receipts. For example, a transactee may have a user device on his person, but the user device may not have a requisite application installed. This may occur for example,, when a user device is new, or when the transactee is unfamiliar with his user device. In existing receipt and payment systems, a user device may be required to register in order to obtain an e-receipt. This registration may include the provision of personal information such as an e-mail address, phone number, payment instrument number, or account information. As a result, computing devices and methods for providing an e-receipt at the time of transaction in the absence of personal information or pre-registration is desired.

Timely provision of an e-receipt may also require Internet connectivity by the POS terminal at the transaction venue, when, in many cases, an Internet connection may not be available. For example, many transactions occur in subway terminals, on airline flights, during network outages, and in other situations where Internet connectivity is unavailable. As a result, computing devices and methods for providing an e-receipt at the time of transaction in the absence of web connectivity are also desired.

### SUMMARY

Examples described herein can provide computing devices and methods for issuing electronic receipts, such that a transactee may immediately receive an e-receipt. The e-receipt may be received, for example, at a user device.

Examples described herein can allow the computing device to issue electronic receipts in the absence of web connectivity.

Examples described herein can allow a transactee, immediately after a transaction has occurred, to receive and view a corresponding e-receipt using a web browser application. Examples described herein allow a transactee, immediately after a transaction has occurred, to receive and view a corresponding e-receipt on a user device.

Conventionally, issuing an e-receipt requires that a particular application be pre-installed on a consumer's smartphone, or it is necessary to login. However, since an e-receipt according to the some example embodiments may be checked in the form of a web page through a browser, a consumer does not need to pre-install a separate application, sign up for a website, or log in to receive an e-receipt.

An example embodiment is a computing device comprising: a communications module; a processor; and at least one memory coupled to the processor, and storing instructions which, when executed by the processor, cause the processor to: receive transaction information corresponding to a transaction, the transaction including one or more purchases and a disbursement, the transaction information including a plurality of receipt elements, the plurality of receipts elements including date information and time information; send, to a transfer rail, the transaction information; generate, using a hash function applied to the transaction information, and/or using the date information and time information, and/or using a unique device identifier: a unique transaction identifier; generate a uniform resource locator (URL) which includes the unique transaction identifier; receive, from the transfer rail, a confirmation of a successful completion of a transfer card transaction corresponding to the transaction information; and send, to an NFC tag controller, the URL.

In an example embodiment of any of the above computing devices, the URL further includes the at least some of the plurality of receipt elements including a transactor name, a transaction date, an identification of the one or more purchases, or a total disbursement amount.

In an example embodiment of any of the above computing devices, the processor is further caused to determine an absence of Internet connectivity at the computing device; wherein the sending includes sending, via the NFC tag controller, the URL to a user device; wherein the URL includes the at least some of the plurality of receipt elements so that the user device is able to generate, by parsing the URL and without accessing the URL on the Internet, a receipt of the transaction.

In an example embodiment of any of the above computing devices, the sending includes sending, via the NFC tag controller and to a user device, an NFC data exchange format (NDEF) message comprising the URL as a payload.

In an example embodiment of any of the above computing devices, the computing device is a PIN Transaction Service Point of Interaction (PTS POI) device and the unique device identifier is a unique device identifier of the PTS POI device.

In an example embodiment of any of the above computing devices, the processor is further caused to, prior to the receiving a confirmation of a successful completion of a transfer card transaction: determine an absence of Internet connectivity at the computing device.

In an example embodiment of any of the above computing devices, the processor is further caused to, prior to the receiving the confirmation of the successful completion of the transfer card transaction corresponding to the transaction information: send, via the communications module, to a server, the transaction information and the URL, wherein the URL identifies a web resource corresponding to a receipt of the transaction.

In an example embodiment of any of the above computing devices, the processor is further caused to, prior to the sending, to the transfer rail, the transaction information: receive, from a card reader (CR) device, transfer card data, the CR device comprising the NFC tag controller; and send, to the transfer rail, the transfer card data, wherein the unique device identifier is a unique device identifier of the CR device.

In an example embodiment of any of the above computing devices, the computing device further comprises: the NFC tag controller, wherein the processor is further caused to: generate, via the NFC tag controller, an NFC data exchange format (NDEF) message comprising the URL as a payload; and emit, via the NFC tag controller, an NFC signal corresponding to the NDEF message.

In an example embodiment of any of the above computing devices, the computing device further comprises: an NFC tag reader; wherein prior to the generating the URL, the processor is further caused to: receive, via the NFC tag reader, transfer card data; and send, to the transfer rail, the transfer card data, wherein the URL further includes the unique device identifier, wherein the unique device identifier is of the computing device.

In an example embodiment of any of the above computing devices, the computing device is a contactless PIN entry on Commercial off-the-shelf (CPoC) device, a software-based PIN entry on Commercial off-the-shelf device, or a mobile payments on commercial-off-the-shelf devices (MPoC) device.

Another example embodiment is a computing device comprising: a communications module; a processor; and at least one memory coupled to the processor, and storing instructions which, when executed by the processor, cause the processor to: receive transaction information corresponding to a transaction, the transaction including one or more purchases and a disbursement, the transaction information including a plurality of receipt elements; determining that there is no Internet connectivity; generate, as a consequence to determining that there is no Internet connectivity, a uniform resource locator (URL) which includes at least some of the plurality of receipt elements including a transactor name, a transaction date, an identification of the one or more purchases, or a total disbursement amount; and send, via an NFC tag controller and to a user device, an NFC data exchange format (NDEF) message comprising the URL as a payload, wherein the URL is formatted such that the user device is able to generate, by parsing the URL and without accessing the URL on the Internet, a receipt of the transaction.

In an example embodiment of any of the above computing devices, the processor is further caused to: determine that there is the Internet connectivity; send, via the communications module, to a server, the transaction information and the URL, wherein the URL identifies a web resource corresponding to a second receipt of the transaction.

Another example embodiment is a user device, comprising: a processor; and at least one memory coupled to the processor, and storing instructions which, when executed by the processor, cause the user device to: receive, as a string, a uniform resource locator (URL), the URL identifying a web resource corresponding to a transaction; parse the string into a plurality of components; determine an association between at least two of the plurality of components with a respective receipt element identifier; and generate a second receipt containing at least two of the respective receipt element identifiers.

In an example embodiment of any of the above user devices, the user device is further caused to: store the second receipt at a first location.

In an example embodiment of any of the above user devices, the user device is further caused to: access the web resource corresponding to a first receipt of the transaction identified by the URL; and store the first receipt at the first location.

In an example embodiment of any of the above user devices, the user device is further caused to: prior to the generating the second receipt, receive a selection of desired receipt element identifiers, wherein the at least two of the respective receipt element identifiers in the second receipt correspond to the selection of the desired receipt element identifiers.

In an example embodiment of any of the above user devices, the selection of the desired receipt element identifiers is received via a graphical user interface.

In an example embodiment of any of the above user devices, the URL includes a unique transaction identifier and at least a transactor name, a transaction date, an identification of one or more purchases, or a total disbursement amount.

In an example embodiment of any of the above user devices, the unique transaction identifier is generated using a hash function applied to transaction information, and/or using date information and time information associated with the transaction, and/or using a unique device identifier.

Another example embodiment is a computer-implemented method comprising: receiving transaction information corresponding to a transaction, the transaction including one or more purchases and a disbursement, the transaction information including a plurality of receipt elements, the plurality of receipts elements including date information and time information; sending, to a transfer rail, the transaction information; generating, using a hash function applied to the transaction information, and/or using the date information and time information, and/or using a unique device identifier: a unique transaction identifier; generating a uniform resource locator (URL) which includes the unique transaction identifier and at least some of the plurality of receipt elements, the at least some of the plurality of receipt elements including a transactor name, a transaction date, an identification of the one or more purchases, or a total disbursement amount; receiving, from the transfer rail, a confirmation of a successful completion of a transfer card transaction corresponding to the transaction information; and sending, to an NFC tag controller, the URL.

In an example embodiment of any of the above computer-implemented methods, prior to the receiving the confirmation of the successful completion of the transfer card transaction corresponding to the transaction information, the method further comprises: sending, to a server, the transaction information and the URL, wherein the URL identifies a web resource corresponding to a receipt of the transaction.

In an example embodiment of any of the above computer-implemented methods, prior to the sending, to the transfer rail, the transaction information, the method further comprises: receiving, from a card reader (CR) device, transfer card data, the CR device comprising the NFC tag controller; and sending, to the transfer rail, the transfer card data, wherein the unique device identifier a unique device identifier of the CR device.

In an example embodiment of any of the above computer-implemented methods, the computer-implemented method further comprises: generating, via the NFC tag controller, an NFC data exchange format (NDEF) message comprising the URL as a payload; and emitting, via the NFC tag controller, an NFC signal corresponding to the NDEF message.

In an example embodiment of any of the above computer-implemented methods, prior to the generating the URL, the method further comprises: receiving, via an NFC tag reader, transfer card data; and sending, to the transfer rail, the transfer card data.

Another example embodiment is a non-transitory computer readable medium containing instructions which, when executed by the processor, cause the processor to: receive transaction information corresponding to a transaction, the transaction including one or more purchases and a disbursement, the transaction information including a plurality of receipt elements, the plurality of receipts elements including date information and time information; send, to a transfer rail, the transaction information; generate, using a hash function applied to the transaction information, and/or using the date information and time information, and/or using a unique device identifier: a unique transaction identifier; generate a uniform resource locator (URL) which includes the unique transaction identifier and at least some of the plurality of receipt elements, the at least some of the plurality of receipt elements including a transactor name, a transaction date, an identification of the one or more purchases, or a total disbursement amount; receive, from the transfer rail, a confirmation of a successful completion of a transfer card transaction corresponding to the transaction information; and send, to an NFC tag controller, the URL.

Another example embodiment is a non-transitory computer readable medium containing instructions which, when executed by the processor, cause the processor to: receive, as a string, a uniform resource locator (URL), the URL identifying a web resource corresponding to a transaction; parse the string into a plurality of components; determine an association between at least two of the plurality of components with a respective receipt element identifier; and generate a second receipt containing at least two of the respective receipt element identifiers.

Another example embodiment is a computer-implemented method comprising: receiving, as a string, a uniform resource locator (URL) identifying a web resource corresponding to a transaction; parsing the string into a plurality of components; determining an association between at least two of the plurality of components with a respective receipt element identifier; and generating a second receipt containing at least two of the respective receipt element identifiers.

Another example embodiment is a computing device comprising: an NFC tag controller; a communications module; a processor; and at least one memory coupled to the processor, and storing instructions which, when executed by the processor, cause the processor to: receive, via the communications module, transaction information corresponding to a transaction, the transaction including one or more purchases and a disbursement, the transaction information including a plurality of receipt elements, the plurality of receipts elements including date information and time information; generate, using a hash function applied to the transaction information, and/or using the date information and time information, and/or using a unique device identifier: a unique transaction identifier; generate a URL which includes the unique transaction identifier; send, to a server, the transaction information and the URL; generate, via the NFC tag controller, an NFC data exchange format (NDEF) message comprising the URL as a payload; emit, via the NFC tag controller to a user device, an NFC signal corresponding to the NDEF message, wherein the URL identifies a web resource at the server corresponding to a receipt of the transaction, the receipt being generated by the server in response to receiving the transaction information, and wherein the user device, upon receipt of the NFC signal, immediately displays the receipt through a web page or an application page corresponding to the URL without using an e-mail address, a text message, or an execution of a pre-loaded or pre-installed application.

Another example embodiment is a computer-implemented method comprising: receiving transaction information corresponding to a transaction, the transaction including one or more purchases and a disbursement, the transaction information including a plurality of receipt elements, the plurality of receipts elements including date information and time information; generating, using a hash function applied to the transaction information, and/or using the date information and time information, and/or using a unique device identifier: a unique transaction identifier; generating a URL which includes the unique transaction identifier; sending, to a server, the transaction information and the URL; generating, via the NFC tag controller, an NFC data exchange format (NDEF) message comprising the URL as a payload; emitting, via the NFC tag controller to a user device, an NFC signal corresponding to the NDEF message, wherein the URL identifies a web resource at the server corresponding to a receipt of the transaction, the receipt being generated by the server in response to receiving the transaction information, and wherein the user device, upon receipt of the NFC signal, immediately displays the receipt through a web page or an application page corresponding to the URL without using an e-mail address, a text message, or an execution of a pre-loaded or pre-installed application.

Another example embodiment is a non-transitory computer readable medium containing instructions which, when executed by the processor, cause the processor to: receive, via the communications module, transaction information corresponding to a transaction, the transaction including one or more purchases and a disbursement, the transaction information including a plurality of receipt elements, the plurality of receipts elements including date information and time information; generate, using a hash function applied to the transaction information, and/or using the date information and time information, and/or using a unique device identifier: a unique transaction identifier; generate a URL which includes the unique transaction identifier; send, to a server, the transaction information and the URL; generate, via the NFC tag controller, an NFC data exchange format (NDEF) message comprising the URL as a payload; emit, via the NFC tag controller to a user device, an NFC signal corresponding to the NDEF message, wherein the URL identifies a web resource at the server corresponding to a receipt of the transaction, the receipt being generated by the server in response to receiving the transaction information, and wherein the user device, upon receipt of the NFC signal, immediately displays the receipt through a web page or an application page corresponding to the URL without using an e-mail address, a text message, or an execution of a pre-loaded or pre-installed application.

### BRIEF DESCRIPTION OF THE DRAWINGS

Example embodiments are described in detail below, with reference to the following drawings:

FIG. 1 is a schematic diagram showing an e-receipt issuing computing system according to example embodiments;

FIG. 2 is a block diagram showing an example of the internal configuration of an e-receipt generator as shown in FIG. 1, according to example embodiments;

FIG. 3 is a block diagram showing an example of an internal configuration of a server as shown in FIG. 1, according to example embodiments;

FIG. 4 is a block diagram showing an example of an internal configuration of a user device as shown in FIG. 1, according to example embodiments;

FIG. 5 is a schematic diagram showing an example of an e-receipt issuing computing system, according to example embodiments.

FIG. 6 is a flowchart of an example method of issuing an e-receipt, according to example embodiments;

FIG. 7 is a diagram of an example display of an e-receipt on a user device, according to example embodiments;

FIG. 8 is a flowchart of an example method of issuing an e-receipt, according to example embodiments;

FIG. 9 is a diagram showing an example display of a waiting room on a user device, according to example embodiments;

FIG. 10 is a schematic diagram showing components of a an e-receipt issuing computing system according to example embodiments;

FIG. 11 is a flowchart of an example method for generating an e-receipt, according to example embodiments;

FIG. 12 is a schematic diagram showing components of a an e-receipt issuing computing system according to example embodiments;

FIG. 13 is a flowchart of an example method for generating an e-receipt, according to example embodiments;

FIG. 14 is a schematic diagram showing components of a an e-receipt issuing computing system according to example embodiments;

FIG. 15 is a flowchart of an example method for generating a second e-receipt, according to example embodiments;

FIG. 16 illustrates an example display screen of a receipt management user interface, according to example embodiments; and

FIG. 17 illustrates an example display screen 1500 of a second e-receipt, according to example embodiments.

Like reference numerals may be used in the drawings to denote like elements and features.

### DETAILED DESCRIPTION

At least some example embodiments include a method of issuing electronic receipts (e-receipts or receipts), such that a user may conveniently check the same on a smartphone, and thus a business operator may use the method.

Since the example embodiments can apply various transformations and can have various embodiments, specific embodiments are illustrated in the drawings and described in detail in the detailed description. However, this is not intended to limit to particular modes of practice, and it is to be appreciated that all changes, equivalents, and substitutes that do not depart from the technical scope of the example embodiments. In the detailed description, certain detailed explanations of the related art are omitted when it is deemed that they may unnecessarily obscure the clarity of the example embodiments.

An example embodiment is a computer-implemented method comprising: receiving transaction information corresponding to a transaction, the transaction including one or more purchases and a disbursement, the transaction information including a plurality of receipt elements, the plurality of receipts elements including date information and time information; sending, to a transfer rail, the transaction information; generating, using a hash function applied to the transaction information, and/or using the date information and time information, and/or using a unique device identifier: a unique transaction identifier; generating a uniform resource locator (URL) which includes the unique transaction identifier and at least some of the plurality of receipt elements, the at least some of the plurality of receipt elements including a transactor name, a transaction date, an identification of the one or more purchases, or a total disbursement amount; receiving, from the transfer rail, a confirmation of a successful completion of a transfer card transaction corresponding to the transaction information; and sending, to an NFC tag controller, the URL.

Another example embodiment is a computer-implemented method comprising: receiving, as a string, a uniform resource locator (URL) identifying a web resource corresponding to a transaction; parsing the string into a plurality of components; determining an association between at least two of the plurality of components with a respective receipt element identifier; and generating a second receipt containing at least two of the respective receipt element identifiers.

Another example embodiment is a computing device comprising: an NFC tag controller; a communications module; a processor; and at least one memory coupled to the processor, and storing instructions which, when executed by the processor, cause the processor to: receive, via the communications module, transaction information corresponding to a transaction, the transaction including one or more purchases and a disbursement, the transaction information including a plurality of receipt elements, the plurality of receipts elements including date information and time information; generate, using a hash function applied to the transaction information, and/or using the date information and time information, and/or using a unique device identifier: a unique transaction identifier; generate a URL which includes the unique transaction identifier; send, to a server, the transaction information and the URL; generate, via the NFC tag controller, an NFC data exchange format (NDEF) message comprising the URL as a payload; emit, via the NFC tag controller to a user device, an NFC signal corresponding to the NDEF message, wherein the URL identifies a web resource at the server corresponding to a receipt of the transaction, the receipt being generated by the server in response to receiving the transaction information, and wherein the user device, upon receipt of the NFC signal, immediately displays the receipt through a web page or an application page corresponding to the URL without using an e-mail address, a text message, or an execution of a pre-loaded or pre-installed application.

Another example embodiment is a computer-implemented method comprising: receiving transaction information corresponding to a transaction, the transaction including one or more purchases and a disbursement, the transaction information including a plurality of receipt elements, the plurality of receipts elements including date information and time information; generating, using a hash function applied to the transaction information, and/or using the date information and time information, and/or using a unique device identifier: a unique transaction identifier; generating a URL which includes the unique transaction identifier; sending, to a server, the transaction information and the URL; generating, via the NFC tag controller, an NFC data exchange format (NDEF) message comprising the URL as a payload; emitting, via the NFC tag controller to a user device, an NFC signal corresponding to the NDEF message, wherein the URL identifies a web resource at the server corresponding to a receipt of the transaction, the receipt being generated by the server in response to receiving the transaction information, and wherein the user device, upon receipt of the NFC signal, immediately displays the receipt through a web page or an application page corresponding to the URL without using an e-mail address, a text message, or an execution of a pre-loaded or pre-installed application.

Another example embodiment is a method of issuing an electronic receipt, the method includes receiving transaction information related to a transaction, generating an address corresponding to the transaction information, storing the transaction information in a server in response to the address, transmitting the generated address to a user device through wireless communication technology, and displaying, by the user device, an e-receipt generated in response to the transaction information through the transmitted address.

Another example embodiment is a computing device, including a communications module; a processor; and at least one memory coupled to the processor, and storing instructions which, when executed by the processor, cause the processor to perform any of the methods described herein.

Another example embodiment is a non-transitory computer readable medium containing instructions which, when executed by the processor, cause the processor to perform any of the methods described herein.

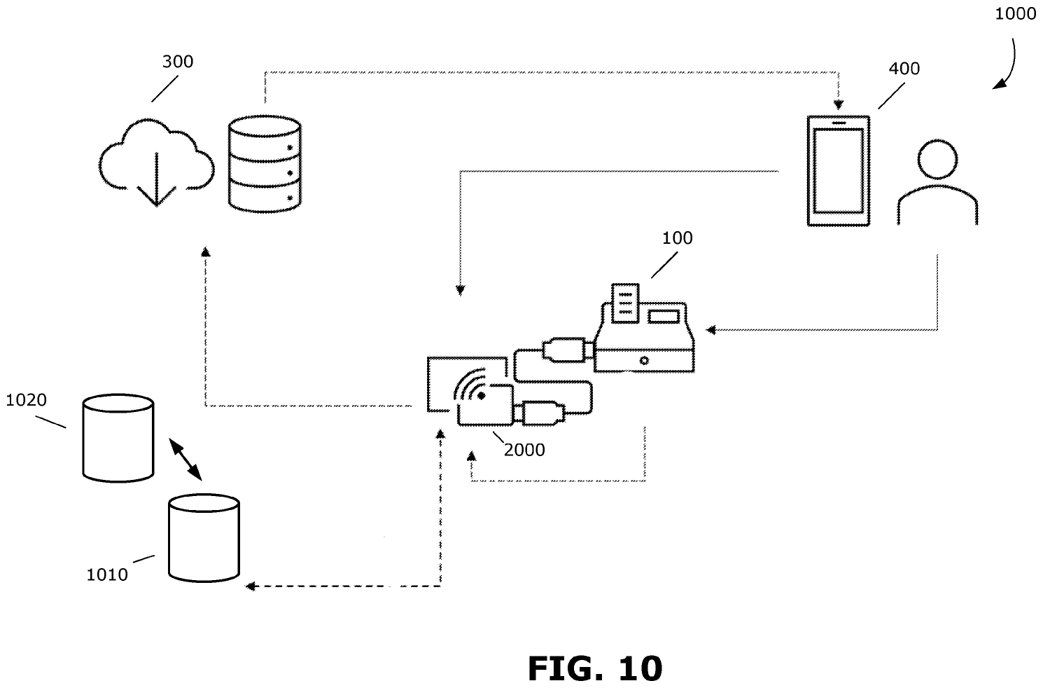

FIG. 10 is a diagram showing an e-receipt issuing computing system 1000 according to an example embodiment. Referring to FIG. 10, the e-receipt issuing computing system 1000 is shown including a POS terminal 100, an e-receipt generator 2000, a server 300, a transfer rail 1010, an issuer computing device 1020, and a user device 400. The e-receipt generator 2000 is a computing device. In the example illustrated by FIG. 10, the e-receipt generator 2000 may operate as a PIN transaction Service, Point of Interaction (PTS POI) device.

The POS terminal 100, the server 300, the e-receipt generator 2000, the transfer rail 1010, the issuer computing device 1020, and the user device 400 may be in communication over a network (not shown), for example, a wireless network. In some implementations, the wireless network may be the Internet. In some implementations, the POS terminal 100, the server 300, the e-receipt generator 2000, the transfer rail 1010, the issuer computing device 1020, and the user device 400 may connect to the Internet via Wi-Fi technology. The user device 400 may include an NFC tag reader. In other words, the user device 400 may include NFC Reading or a Background NFC Tag reading capability.

As illustrated, the POS terminal 100 may communicate with the e-receipt generator 2000, which may operate to generate an e-receipt. Such communication may be via a wired connection, such as, for example, a USB connection. Such communication may be via a wireless connection, such as Bluetooth™M, for example. The POS terminal 100 may include a physical token reader. The physical token reader may be described as an NFC tag reader.

The e-receipt generator 2000 may communicate with the transfer rail 1010, which relays transaction data to an appropriate issuer computing device 1020. Such communication may be via a network, such as a wireless network. The transfer rail 1010 may also be referred to as a payment rail. In examples, the transfer rail 1010 is a payment processor, platform, server, or network infrastructure that allows electronic money transfers to be made between payers and payees. In examples, the transfers can be made regardless of country, currency, digital payment method, or whether the payer or payee is a business or consumer. Each payment rail differs in how it carries out this process based on the payment type, speed, technology, or geographical location. Examples of the transfer rail 1010 include Automated Clearing House (ACH), Mastercard, VISA (and other major credit card providers), PayPal, the RTP Network, blockchain, SWIFT, and SEPA.

The POS terminal 100 and/or the e-receipt generator 2000 may be associated with an acquirer and the communication between the POS terminal 100 and/or the e-receipt generator 2000 and the transfer rail 1310 may be by way of a back-end acquirer computing device. The POS terminal 100 may be located at a location that is associated with a transactor, such as a merchant. By way of example, the merchant may be a store, restaurant, gym, etc. The acquirer may be a merchant bank that accepts deposits associated with transactions made at the POS terminal 100 and facilitates settlement and deposit of those deposits into an account associated with the merchant. In some examples, the POS terminal 100 can issue e-receipts for legal tender (cash) transactions as well.

While a single transfer rail 1010 is illustrated in FIG. 10, in practice the POS terminal 100 and/or the e-receipt generator 2000 may communicate with multiple transfer rails. By way of example, the transfer rail 1010 may include any one or a combination of Amex™, Visa™ and/or Mastercard™. Other transfer rails may also be used. The POS terminal 100, the e-receipt generator 2000 and/or a back-end acquirer computing device in communication with the POS terminal 100 and/or the e-receipt generator 2000 may, after obtaining data from a physical token, such as a value transfer card or a user device 400 having a representation of a payment card which has engaged a physical token reader provided at the POS terminal 100, determine which of the transfer rails is to be used. For example, the POS terminal/acquirer computing device may determine that the physical token is associated with Visa™ and may, in response, select the Visa™ payment rail or it may, instead, determine that the physical token is associated with Mastercard™ and select the Mastercard™ payment rail.

After a transfer rail 1010 is identified, the POS terminal/e-receipt generator/acquirer computing device sends the transfer rail 1010 a message. The message may be sent through a network. The message may include a value amount representing an amount of value that is to be transferred to complete a transaction and physical token data such as a primary account number (PAN) associated with a physical token. The transfer rail 1010 identifies an associated issuer based on the physical token data and communicates with the identified issuer to process the transaction. More particularly, the transfer rail 1010 routes the message received from the POS terminal 100 and/or the e-receipt generator 2000 to an issuer computing device 1020 for the identified issuer. The issuer computing device 1020 then determines whether the transaction is approved or denied based on pre-defined rules. The rules may, for example, consider any one or more of: whether the cardholder has available funds, whether the merchant is of a type that is permitted, whether the transaction violates any spending limits, etc.

When the issuer computing device 1020 determines whether to approve or deny the transaction, it sends a message indicating the result of this determination to the POS terminal 100 and/or the e-receipt generator via the transfer rail 1010. The result may then be displayed or otherwise output at the POS terminal 100.

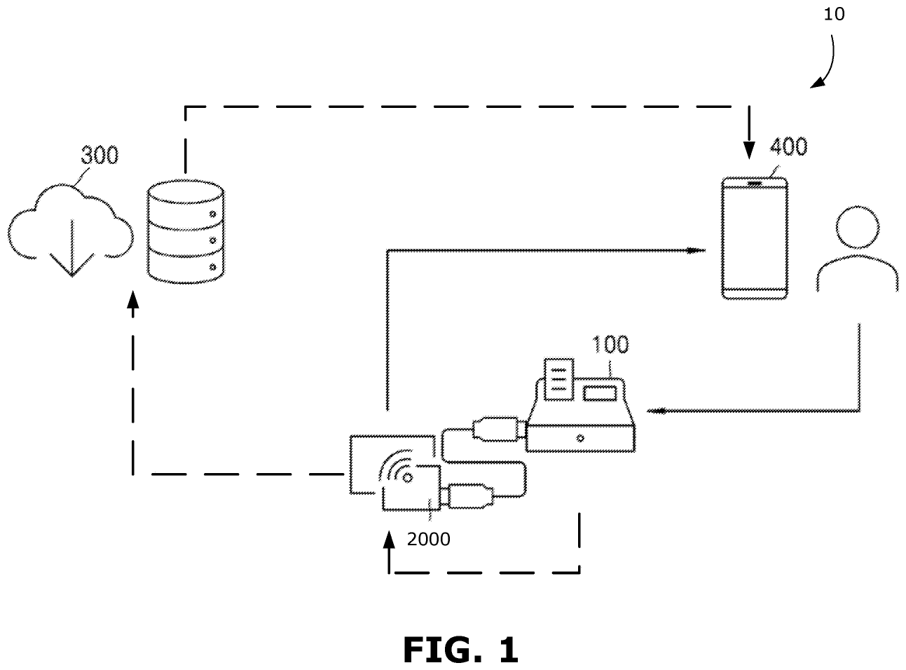

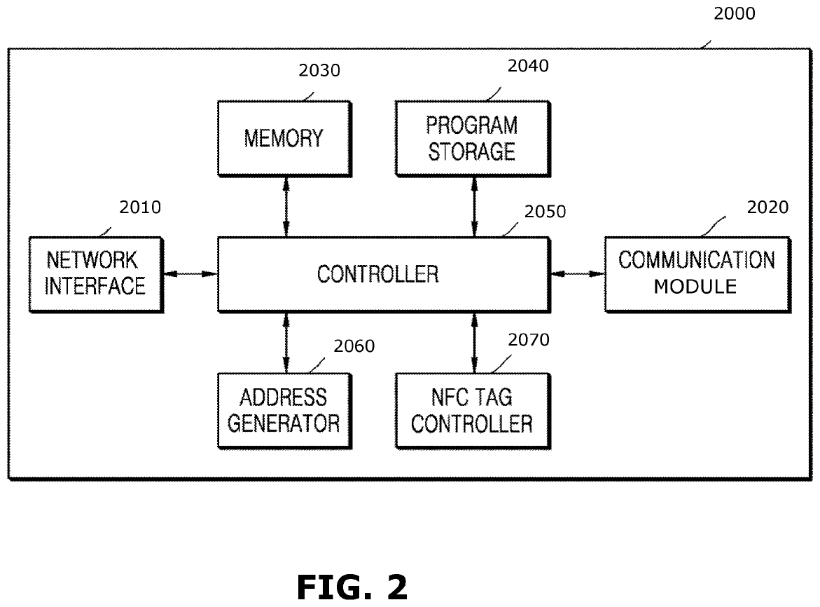

FIG. 2 is a block diagram showing an example of the internal configuration of the e-receipt generator 2000 shown in FIGS. 1 and 10. Referring to FIG. 2, the e-receipt generator 2000 may include a variety of components. The variety of components may include, as shown, a network interface 2010, a communication module 2020, a memory 2030, a program storage 2040, a controller 2050, an address generator 2060, and an NFC tag controller 2070, for example.

In some embodiments, two or more functionally connected components 2010, 2020, 2030, 2040, 2050, 2060 and 2070 may be combined with each other and exist as a single component. In some embodiments, one component may be divided into a plurality of components according to one or more functions of the one component.

The network interface 2010 provides an interface for transmitting an address, e.g. a URL, and transaction information corresponding thereto to a server 300, in conjunction with a communication network.

The communication module 2020 allows the e-receipt generator 2000 to communicate with other computer or computing devices and/or various communications networks. For example, the communication module 2020 may allow the e-receipt generator 2000 to send or receive communications signals. Communications signals may be sent or received according to one or more protocols or according to one or more standards. For example, the communications module 2020 may allow the e-receipt generator 2000 to communicate via a cellular data network, such as for example, according to one or more standards such as, for example, Global Computing device for Mobile Communications (GSM), Code Division Multiple Access (CDMA), Evolution Data Optimized (EVDO), Long-term Evolution (LTE) or the like. Additionally or alternatively, the communication module 2020 may allow the e-receipt generator 2000 to communicate using NFC, via Wi-Fi™, using Bluetooth™ or via some combination of one or more networks or protocols. In some embodiments, all or a portion of the communication module 2020 may be integrated into a component of the e-receipt generator 2000. For example, the communication module 2020 may be integrated into a communications chipset. The communication module may include a communication interface for receiving transaction information from the POS terminal 100.

The memory 2030 temporarily stores data processed by the controller 2050 and/or temporarily stores transaction information transmitted to the e-receipt generator 2000.

The program storage 2040 stores control software for performing a task of transmitting data to the server 300, a task of receiving data from the POS terminal 100, a task of generating an address corresponding to transaction information, a task of generating a message corresponding to an address and programming the message to an NFC tag, etc. In some embodiments, the program storage may form part of the memory 2030. In some embodiments, some or all of the control software stored in the program storage may form at least part of one or more applications within the memory 2030.

The controller 2050 is a kind of central processing module (CPU) and may control the process related to the generation of an e-receipt in the e-receipt generator 2000. In other words, the controller 2050 may perform various services such as executing control software stored in the program storage 2040.

The address generator 2060 may generate a unique address in correspondence to

received transaction information. In some embodiments, an address refers to a URL for accessing a web site or a web page on the Internet, but the example embodiments are not limited thereto.

The address generator 2060 may generate a unique address by including therein a unique transaction identifier corresponding to transaction information. For example, in some implementations, an address may have the format “www.domain/unique_transaction identifier/receipt elements.” The “receipt elements” of the URL may relate to the transaction information. In some such implementations, the format of the unique transaction identifier may include various lengths and may be based on a combination of letters, numbers, and special characters, although the example embodiments are not limited thereto.

According to an embodiment, the e-receipt generator 2000 may generate an identifier (unique transaction identifier) based on transaction-related information. For example, in some embodiments, an identifier may be generated based on information respecting the e-receipt generator 2000 and/or based on a transaction date and a transaction time. According to another embodiment, the e-receipt generator 2000 may generate an identifier using a hash technique. A hash technique refers to a technique for obtaining one result value corresponding to one input value using a hash function. In some such embodiments, an identifier may be a result value obtained through a hash technique using transaction information as an input value. However, methods of generating an identifier according to the example embodiments are not limited thereto.

The NFC tag controller 2070 generates a message corresponding to an address and emits the message as an NFC signal by controlling an NFC tag. According to an embodiment, a message may be in a particular format used for NFC. In some implementations, the particular format may refer to a format that enables the user device 400 receiving a corresponding message to immediately perform a predetermined action. For example, the NFC tag controller 2070 may generate and emit an NDEF message including information to be transmitted to the user device 400. In some implementations, an address is included as a payload in the NDEF message. In such implementations, the user device 400 may perform a predetermined operation upon receiving the NDEF message. The predetermined operation may be, for example, opening, through a web browser application, a web page linked to the address.

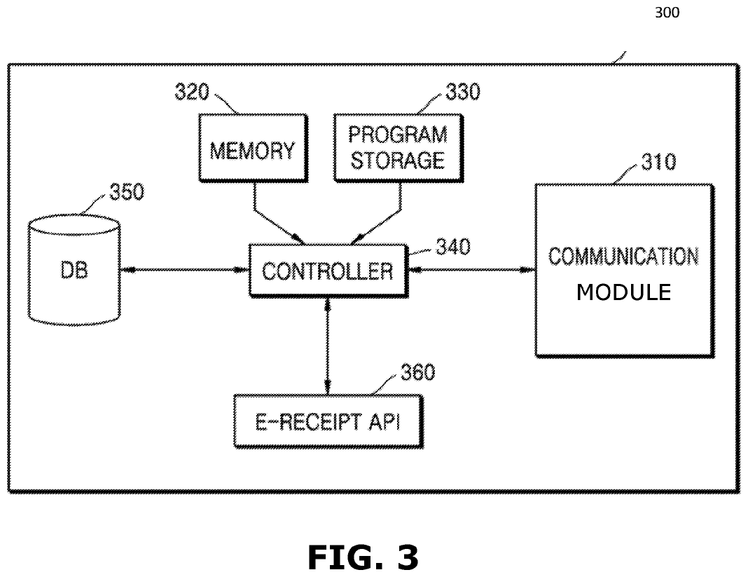

FIG. 3 is a block diagram showing an example of an internal configuration of the server 300 shown in FIGS. 1 and 10. Referring to FIG. 3, the server 300 may include a variety of components. These components may include, as shown, a communication module 310, a memory 320, a program storage 330, a controller 340, a database 350, and an e-receipt application programming interface (API) 360, for example.

The communication module 310 allows the server 300 to communicate with other computer or computing devices and/or various communications networks. For example, the communication module 310 may allow the server 300 to send or receive communications signals. Communications signals may be sent or received according to one or more protocols or according to one or more standards. For example, the communications module 310 may allow the server 300 to communicate via a cellular data network, such as for example, according to one or more standards such as, for example, Global Computing device for Mobile Communications (GSM),

Code Division Multiple Access (CDMA), Evolution Data Optimized (EVDO), Long-term Evolution (LTE) or the like. Additionally or alternatively, the communication module 310 may allow the server 300 to communicate using NFC, via Wi-Fi™, using Bluetooth™ or via some combination of one or more networks or protocols. In some embodiments, all or a portion of the communication module 310 may be integrated into a component of the server 300. For example, the communication module 310 may be integrated into a communications chipset.

The communication module 310 may provide an interface for communication between the server 300 and the user device 400, and between the server 300 and the e-receipt generator 2000. In some embodiments, the communication module 310 may include hardware and software for transmitting and receiving control signals or data signals through a wireless connection with another network device.

The memory 320 may perform a function of temporarily or permanently storing data processed by the controller 340. In some implementations, the memory 320 may include a magnetic storage medium and/or a flash storage medium, although the example embodiments are not limited thereto.

The program storage 330 may store one or more programs composed of commands instructing one or more processes executed by a controller, as will be further discussed below. In some embodiments, the program storage 330 may form part of the memory 320. In some embodiments, one or more of the programs stored in the program storage may form at least part of one or more applications within the memory 2030.

The controller 340 is a type of CPU and may control processes related to issuance of an e-receipt, such as receiving data from the e-receipt generator 2000, and providing an e-receipt to the user device 400. In other words, the controller 340 may perform one or more functions in connection with providing an e-receipt by executing control software stored in the program storage 330 and controlling each component in the server 300.

In some embodiments, the controller 340 may include a plurality of types of devices capable of processing data, such as one or more processors. In the example embodiments, a “processor” may refer to, for example, a data processing device embedded in hardware, having circuitry physically structured to perform functions represented by computing code and/or computer program instructions.

The database 350 may store address information and transaction information. Address information may include addresses (e.g., URLs), their corresponding identifiers, and other information related to addresses. The database 350 may store correspondences between the address information and the transaction information. In this way, the server 300 may easily determine transaction information using information related to an address.

The e-receipt API 360 provides an interface for converting transaction information into the format of an e-receipt through various applications. The e-receipt API 360 also provides an interface for displaying a generated e-receipt in the form of a web page linked to an address.

These components are merely examples, and the example embodiments are not limited thereto. In other words, as occasions demand, the server 300 may further include additional components or some of the above-stated components may be omitted.

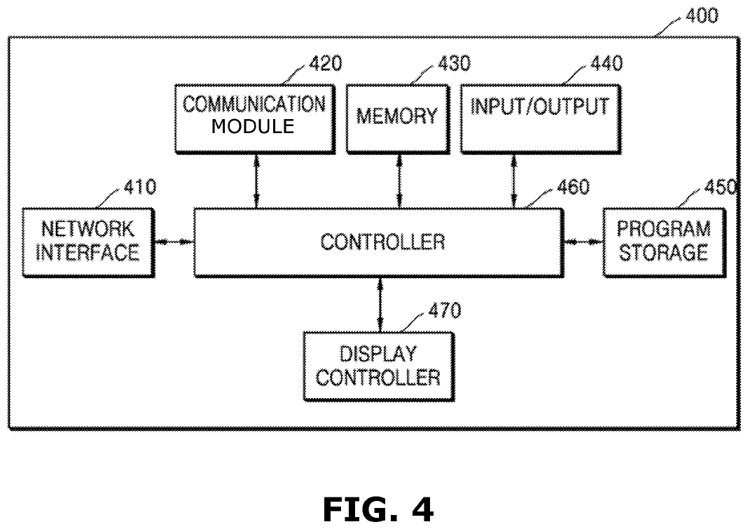

FIG. 4 is a block diagram showing an example of an internal configuration of a user device 400 (FIGS. 1 and 10). Referring to FIG. 4, the user device 400 includes a variety of components. The variety of components may include, as shown, a network interface 410, a communication module 420, a memory 430, an input/output module 440, a program storage 450, a controller 460, and a display controller 470, for example.

The network interface 410 may provide an interface for receiving an e-receipt in conjunction with a communication network.

The communication module 420 allows the user device 400 to communicate with other computer or computing devices and/or various communications networks. For example, the communication module 420 may allow the user device 400 to send or receive communications signals. Communications signals may be sent or received according to one or more protocols or according to one or more standards. For example, the communications module 420 may allow the user device 400 to communicate via a cellular data network, such as for example, according to one or more standards such as, for example, Global Computing device for Mobile Communications (GSM), Code Division Multiple Access (CDMA), Evolution Data Optimized (EVDO), Long-term Evolution (LTE) or the like. Additionally or alternatively, the communication module 420 may allow the user device 400 to communicate using NFC, via Wi-Fi™, using Bluetooth™ or via some combination of one or more networks or protocols. In some embodiments, all or a portion of the communication module 420 may be integrated into a component of the user device 400. For example, the communication module 420 may be integrated into a communications chipset.

The communication module 420 may provide an interface for receiving data from the e-receipt generator 2000 through NFC technology. The user device 400 may include an NFC tag reader. In other words, the user device 400 may include NFC Reading or a Background NFC Tag reading capability.

The memory 430 may temporarily store data processed by the controller 460, and/or may temporarily store an address (e.g., a URL), received from the e-receipt generator 2000.

The input/output (I/O) module 440 may be configured to operate as a touch-sensitive display controller or as another input/output controller. In some examples where the I/O module is operating as a touch-sensitive display controller, the touch-sensitive display controller may provide an output interface and an input interface between a device and a user. In some implementations, the touch-sensitive display controller may transmit electrical signals to and receive electrical signals from the controller 460. In some implementations, the touch-sensitive display controller may display a visual output to the user, and the visual output may include texts, graphics, images, videos, and combinations thereof. In some embodiments, the I/O module 440 may be, for example, a certain display member such as an organic light emitting display (OLED) or a liquid crystal display (LCD), and be capable of recognizing touch input. The I/O module 440 may display, via a web browser application, an e-receipt on a web page accessed based on a received address.

The program storage 450 may store control software for performing tasks such as receiving a message from the e-receipt generator 2000, checking the format of a received message, and, when a received message is an NDEF message, accessing, as a predetermined action, an address included in the NDEF message through a web browser application.

The controller 460 may be a CPU and may control processes related to display of an e-receipt via the user device 400. In other words, the controller 460 may perform various services such as executing control software stored in the program storage 450.

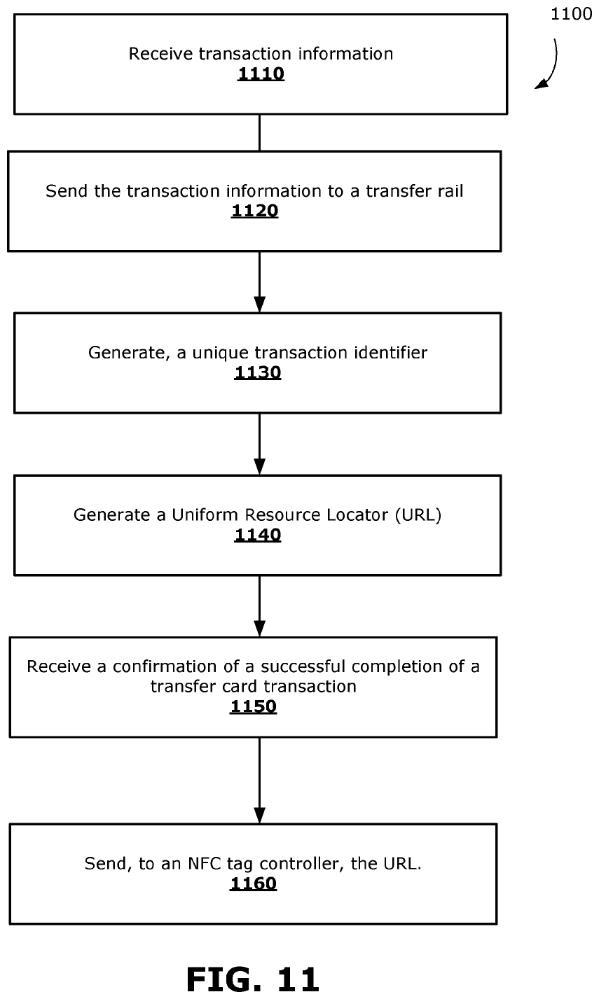

Reference is now made to FIG. 11, which illustrates a flowchart of an example method 1100 of issuing an e-receipt, according to example embodiments. The example method 1100 may be performed by a computing device such as the e-receipt generator 2000 (FIG. 10), which may be operating as a PTS POI device. When operating as a PTS POI device, the e-receipt generator may include a PCI certified payment module, which may reside in the memory of the PTS POI device.

The example method 1100 may be performed, specifically, by a processor of the controller 340 (FIG. 3) of the e-receipt generator 2000 (FIG. 10).

At the operation 1110, the computing device receives transaction information corresponding to a transaction. The transaction information may be received, for example, from the POS terminal 100 (FIG. 10). The transaction may include one or more items and a disbursement. The transaction information may include a plurality of receipt elements, which may include date information and time information. The transaction information may be of a text-based flat file format such as Extensible Markup Language (XML), JavaScript™ Object Notation (JSON), a delimited text file, etc.

At the operation 1120, the computing device sends, to the transfer rail 1010 (FIG. 10), the transaction information. The transaction information may be sent via a module, such as a PCI certified payment module, which may reside in the memory of the computing device. The transfer rail 1010 (FIG. 10) may, contemporaneously, receive transfer card data from the POS terminal 100 (FIG. 10). The transfer card data may include a value amount representing an amount of value that is to be transferred to complete a transaction and physical token data such as a primary account number (PAN) associated with a physical token.

At the operation 1130, the computing device generates a unique transaction identifier. In some examples, the unique transaction identifier may be generated using a hash function applied to the transaction information. Alternatively, in some examples, the unique transaction identifier may be generated using a unique device identifier, and/or date information and time information associated with the transaction. In embodiments where the e-receipt generator 2000 (FIG. 10) is a PTS POI device, the unique device identifier may be a unique device identifier of the PTS POI device. In an example, the unique device identifier is of the computing device. In an example, the unique device identifier is a serial number, ID number, International Mobile Equipment Identity (IMEI), or a Media Access Control (MAC) address of the computing device or the PTS POI device. In examples, the unique transaction identifier may be generated using a combination (concatenation) of the date information, the time information, and the unique device identifier.

At the operation 1140, the computing device generates a unique URL. The unique URL may be based on the unique transaction identifier. The unique URL may identify a web resource corresponding to an electronic receipt of the transaction. The web resource may reside on the server. The unique URL may be of the form: “www.domain/unique transaction identifier/receipt elements”. The “receipt elements” of the URL may relate to the transaction information.

In some embodiments, the computing device may send the transaction information to the server 300 (FIG. 10) via the communications module. The server 300 (FIG. 10) may then generate, at the web resource associated with the URL, a first e-receipt. In some embodiments, the computing device may be unable to communicate with the server 300, e.g., due to an absence of Internet connectivity. In such embodiments, the computing device may transaction information to be sent to the server when communication between the computing device and the server is restored.

At the operation 1150, the computing device receives, from the transfer rail 1010 (FIG. 10), a confirmation of a successful completion of a transfer card transaction corresponding to the transaction information. The confirmation may be received via a module, such as a PCI certified payment module, which may reside in the memory of the computing device. The computing device sends, to the NFC tag controller 2070, a confirmation of the successful completion of a transfer card transaction corresponding to the transaction information. The confirmation can be contained in a NDEF message. If the transaction is declined by the transfer rail 1010, the computing device, to the NFC tag controller 2070, a denial of the transfer card transaction corresponding to the transaction information.

At the operation 1160, the computing device may send the URL to the NFC tag controller 2070. In some embodiments, such as when the computing device is a PTS POI device, the NFC tag controller 2070 may be integral to the PTS POI device. Alternatively, in some embodiments, the NFC tag controller 2070 may be external to the computing device.

Subsequent to receiving the URL, the NFC tag controller 2070 may generate an NDEF message comprising the URL as the payload. The NFC tag controller 2070 may then emit an NFC signal with the URL as the payload.

In some embodiments, the NFC signal may be an NDEF formatted NFC Tag with the URL as the payload. Alternatively, in some embodiments, the NDEF formatted NFC Tag may be, for example, an NDEF formatted Tag with an Apple™ Universal Link URL. Alternatively, in some embodiments, the NDEF formatted NFC Tag may be, for example, an NDEF formatted Tag with an Apple™ App Clips Link URL. Alternatively, in some embodiments, the NDEF formatted NFC Tag may be, for example, an NDEF formatted Tag with an Android™0 App Link URL. Alternatively, in some embodiments, the NDEF formatted NFC Tag may be, for example, an NDEF formatted Tag with an Android™ Instant Apps Link URL. Alternatively, in some embodiments, the NDEF formatted NFC Tag may be, for example, an NDEF formatted Tag with a mini-apps Link URL. In some embodiments, the payload may be a Progressive Web App based URL. Examples include Apple™ “App Clips”, Google™ “Instant Apps,” and Snapchat™ “Snap Minis”.

Once the NFC signal has been emitted, it may be received by the user device 400 (FIG. 10). For example, a shopper may tap the user device 400 (FIG. 10) on the computing device, e.g. the PTS POI device, and receive the URL via the NFC signal. The user device 400 (FIG. 10) may receive the NFC signal, with the URL as a payload, via an NFC Tag reader.

Following the operation 1160, once the NFC signal has been emitted, it may be received by the user device 400 (FIG. 10). For example, a shopper may tap the user device 400 (FIG. 10) on the e-receipt generator 2000 (FIG. 10) and receive the URL via the NFC signal. The user device 400 (FIG. 10) may receive the NFC signal, with the URL as a payload, via an NFC Tag reader.

In some embodiments once the user device 400 (FIG. 10) receives the NFC signal, the NFC tag may launch a web browser application or other application. The web browser application or other application may display the web resource associated with the URL. As noted, the URL may be of the form “www.domain/unique transaction identifier/receipt elements”. The “receipt elements” of the URL may relate to the transaction information. The web resource may contain a first e-receipt.

The web resource may be launched, for example, via a Progressive Web App, via a Responsive Web App (e.g., a JavaScript™-Powered Web App), via Rich Internet App, via Single Page App, or by a Via Multi Page App.

In some embodiments, the user device 400 (FIG. 10) may include an application for the storage and display of receipts. In some such embodiments, the user device 400 (FIG. 10) may be an iOS™ Phone including an Apple™ Universal Link. In such embodiments, once the user device 400 (FIG. 10) receives the NFC signal, the Apple™ Universal Link may cause the first e-receipt to be displayed and/or stored in the application for the storage and display of receipts. In some such embodiments, the user device (FIG. 10) may not be an iOS™ Phone and may include a Deep Link (e.g. an Andriod™ App Link). In such embodiments, once the user device 400 (FIG. 10) receives the NFC signal, the Deep Link may cause the first e-receipt to be displayed and/or stored in the application for the storage and display of receipts. The first e-receipt may be displayed by the application in a format determined by the transactor associated with the transaction.

In some embodiments, the user device 400 (FIG. 10) may not include an application for the storage and display of receipts. In some such embodiments, where the user device 400 (FIG. 10) is an iOS™ Phone including an Apple™ Universal Link, the Apple™ Universal Link may direct the user to the Apple™ App Store to download an application for the storage and display of receipts. In some such embodiments, where the user device 400 (FIG. 10) is not an iOS™ Phone, the Deep Link (e.g. an Andriod™ App Link) may direct the user to ta mobile app store to download an application for the storage and display of receipts. In some such embodiments where the user device 400 (FIG. 10) is an iOST Phone, the user device 400 (FIG. 10) may receive an Apple™ App Clip Link and may launch an App Clip. In some such embodiments, where the user device is a non-iOS™ Phone, the user device 400 (FIG. 10) may receive an Instant App Link and may launch an Instant App. In some such embodiments, the user device 400 (FIG. 10) may receive a mini-app Link and may launch a mini-app.

In some embodiments, a WebNFC framework may be used to provide one or more receipts to the user device 400 (FIG. 10).

In some embodiments, the user device 400 (FIG. 10) may launch a web browser application rendering output at the location of the unique URL, comprising the first e-receipt. The format of the first e-receipt may be in a format decided by the transactor in connection with the first e-receipt. The first e-receipt may be generated using transaction data and may be displayed by the user device using an application. The application may be, for example, a Progressive Web App, a Responsive Web App (such as a JavaScript™-Powered Web App), a Rich Internet App, a Single page App, or a Multi Page App. The first e-receipt may be save to a first location by the corresponding application.

In some embodiments, as noted, the application may be launched by an Apple™ Universal Link or a relevant non-iOS™ mobile application or web application. Where the application is launched by a relevant non-iOS™ application, the application may be launched via Deep Links or by an Android™ App Link. In such embodiments, the application may display the first e-receipt in a format decided by the transactor in connection with the first e-receipt. The first e-receipt may be save to a first location by the corresponding application.

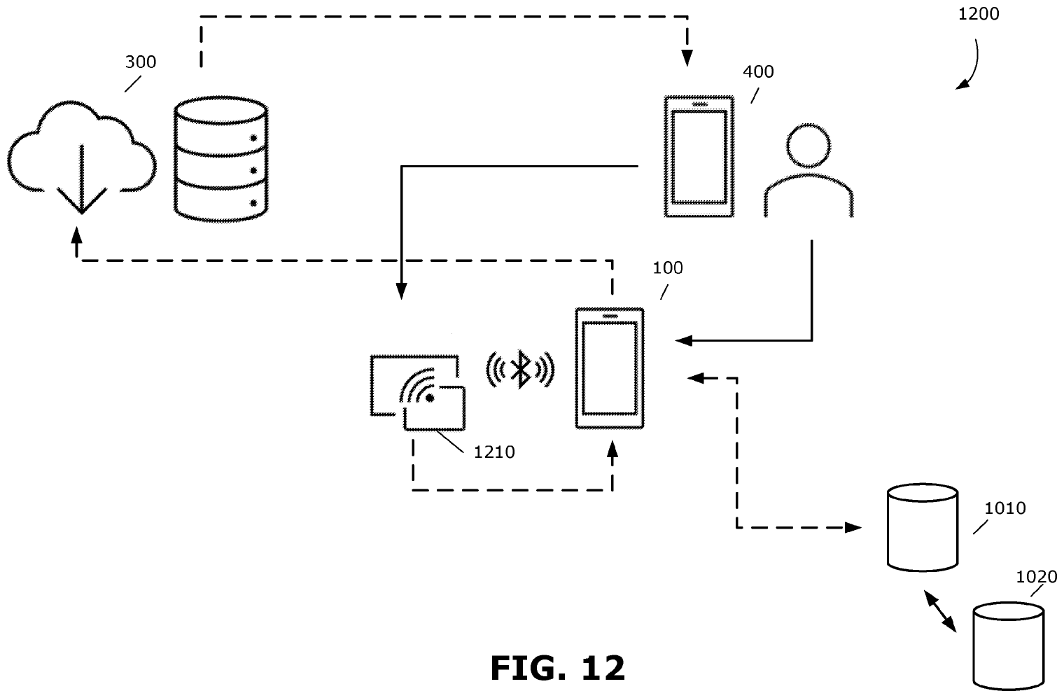

Reference is now made to FIG. 12, which is a diagram showing an e-receipt issuing computing system 1200 according to an example embodiment. Referring to FIG. 12, the e-receipt issuing computing system 1200 is shown including a computing device operating as a POS terminal 100 and including the function of the e-receipt generator 2000 (FIG. 10). The e-receipt issuing computing system is also shown including a server 300, a card reader (CR) device 1210, a transfer rail 1010, an issuer computing device 1020, and a user device 400. In some embodiments, the CR device 1210 of the e-receipt issuing computing system 1200 may be referred to as an NFC enabled PCI Software-based PIN entry on Commercial off-the shelf (SPoC) device card reader. The computing device operating as a POS terminal 100 may be referred to as an SPoC device and/or a Commercial off-the shelf (COTS) device.

The computing device operating as a POS terminal 100, the server 300, the CR device 1210, the transfer rail 1010, the issuer computing device 1020, and the user device 400 may be in communication over a network (not shown), for example, a wireless network. In some implementations, the wireless network may be the Internet. In some implementations, the computing device operating as a POS terminal 100, the server 300, CR device 1210, the transfer rail 1010, the issuer computing device 1020, and the user device 400 may connect to the Internet via Wi-Fi technology. The user device 400 may include an NFC tag reader. In other words, the user device 400 may include NFC Reading or a Background NFC Tag reading capability.

As illustrated, the CR device 1210 may communicate with the computing device operating as a POS terminal 100, which may operate to generate an e-receipt. Such communication may be via a wired connection, such as, for example, a USB connection. Such communication may be via a wireless connection, such as Bluetooth™, for example.

The computing device operating as a POS terminal 100 may communicate with the transfer rail 1010, which relays transaction data to an appropriate issuer computing device 1020. Such communication may be via a network, such as a wireless network. The transfer rail 1010 may also be referred to as a payment rail.

The computing device operating as a POS terminal 100 may be associated with an acquirer and the communication between the computing device operating as a POS terminal 100 and the transfer rail 1010 may be by way of a back-end acquirer computing device. The computing device operating as a POS terminal 100 may be located at a location that is associated with a merchant. By way of example, the merchant may be a store, restaurant, gym, etc. The acquirer may be a merchant bank that accepts deposits associated with transactions made at the computing device operating as a POS terminal 100 and facilitates settlement and deposit of those deposits into an account associated with the merchant.

While a single transfer rail 1010 is illustrated in FIG. 12, in practice the POS terminal 100 and/or the e-receipt generator 2000 may communicate with multiple transfer rails. By way of example, the transfer rail 1010 may include any one or a combination of Amex™, Visa™ and/or Mastercard™. Other transfer rails may also be used. The computing device operating as a POS terminal 100 and/or a back-end acquirer computing device in communication with the computing device operating as a POS terminal 100 may, after obtaining data from a physical token, such as a value transfer card or a mobile device having a representation of a payment card which has engaged the CR device 1210 provided at the POS terminal 100, determine which of the transfer rails is to be used. For example, the POS terminal/acquirer computing device may determine that the physical token is associated with Visa™ and may, in response, select the Visa™ payment rail or it may, instead, determine that the physical token is associated with Mastercard™ and select the Mastercard™ payment rail.

After a transfer rail 1010 is identified, the computing device operating as a POS terminal 100/acquirer computing device sends the transfer rail 1010 a message. The message may be sent through a network. The message may include a value amount representing an amount of value that is to be transferred to complete a transaction and physical token data such as a primary account number (PAN) associated with a physical token. The transfer rail 1010 identifies an associated issuer based on the physical token data and communicates with the identified issuer to process the transaction. More particularly, the transfer rail 1010 routes the message received from the computing device operating as a POS terminal 100 to an issuer computing device 1020 for the identified issuer. The issuer computing device 1020 then determines whether the transaction is approved or denied based on pre-defined rules. The rules may, for example, consider any one or more of: whether the cardholder has available funds, whether the merchant is of a type that is permitted, whether the transaction violates any spending limits, etc.

When the issuer computing device 1020 determines whether to approve or deny the transaction, it sends a message indicating the result of this determination to the computing device operating as a POS terminal 100 via the transfer rail 1010. The result may then be displayed or otherwise output at the POS terminal 100.

The computing device operating as a POS terminal 100 may be a commercial off-the-shelf (CTOS) device, and may include a PCI certified payment module. The computing device operating as a POS terminal 100 may be, for example, laptop, a tablet, a smart phone, or the like. In the embodiment of the e-receipt issuing computing system 1200 illustrated by FIG. 12, the computing device operating as a POS terminal 100 includes the function of the e-receipt generator 2000 (FIG. 10).

The user device 400 may include a mobile wallet that stores a representation of a payment card. A physical token may be connected to one or more accounts (such as banking accounts) that store data and/or resources accessible to the cardholder. By way of example, the physical token may be associated with a bank account and/or a credit card account. The physical token may act as a credit card or a debit card. A physical token may be used for making purchases at a point-of-sale terminal. Such physical tokens may be configured for tap-style payments in which the physical token is placed in a communication range of a physical token reader, such as the CR device 1210, to allow physical token data to be read from the physical token.

The user device 400 may be configured for near-field communication (NFC) payment processing or for wireless communication-based payment processing of another type.

The CR device 1210 is in communication with the computing device operating as the POS terminal 100. The CR device 1210 may be configured to read a physical token such as a transfer card or a mobile device having a representation of a transfer card stored thereon. In this way, the CR device 1210 may be configured to receive transfer card data. The physical token reader may be or include a card slot which facilitates communication with the physical token through physical contact and/or a contactless reader such as a near field communication (NFC) reader which may facilitate communication with the physical token through communication protocols that do not rely on physical contact with the physical token. The CR device 1210 may include an NFC tag controller 2070.

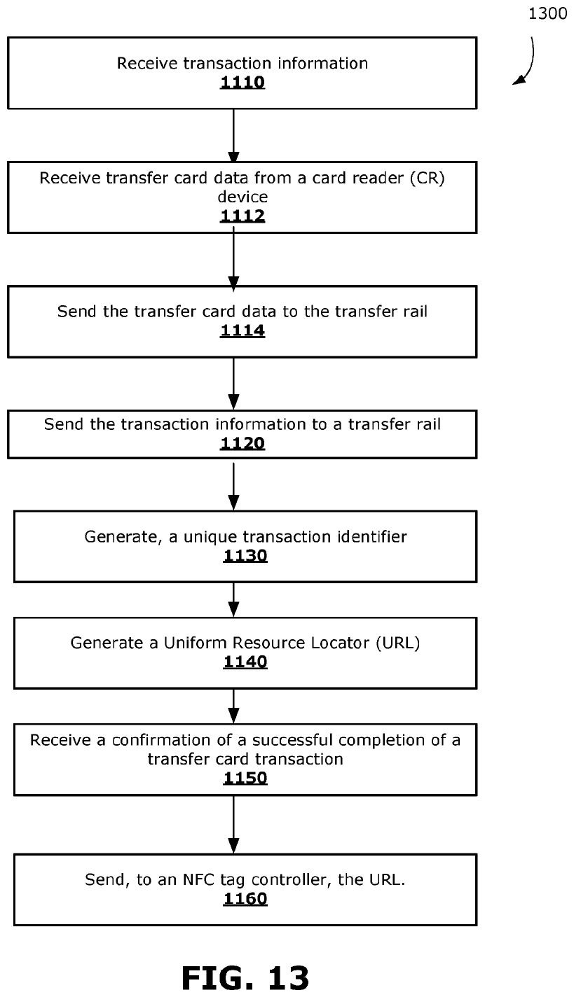

Reference is now made to FIG. 13, which illustrates a flowchart of an example method 1300 of issuing an e-receipt, according to example embodiments. The example method 1300 may be performed by a computing device such as the computing device operating as a POS terminal 100 (FIG. 12). The computing device operating as a POS terminal 100 (FIG. 12) may include a PCI certified payment module, which may reside in the memory of the computing device. In some embodiments, the computing device operating as a POS terminal 100 (FIG. 12) may be a CPoC device and/or an SPoC device.

The example method 1300 may be performed, specifically, by a processor of the controller 340 (FIG. 3) of the computing device operating as a POS terminal 100 (FIG. 12).

The example method 1300 varies from the example method 1100 of FIG. 11 in that the example method 1300 contains two additional operations 1112, 1114 between the operations 1110 and 1120 of the example method 1100 of FIG. 11.

At the operation 1110, the computing device receives transaction information corresponding to a transaction. The transaction may include one or more items and a disbursement. The transaction information may include a plurality of receipt elements, which may include date information and time information. The transaction information may be of a text-based flat file format such as Extensible Markup Language (XML), JavaScript™ Object Notation (JSON), a delimited text file, etc.

In some embodiments, after the operation 1110, the computing device may activate the CR device 1210 (FIG. 12) to retrieve transfer card data.

At the operation 1112, the computing device receives, from the CR device 1210

(FIG. 12), transfer card data. The transfer card data may be received via a wired connection, such as, for example, a USB connection. The transfer card data may be received via a wireless connection, such as Bluetooth™, for example.

As noted, the CR device 1210 (FIG. 12) may include an NFC tag controller 2070. The CR device 1210 (FIG. 12) may be configured to read a physical token such as a transfer card or a mobile device having a representation of a transfer card stored thereon. In this way, the CR device 1210 (FIG. 12) may be configured to receive transfer card data. The physical token reader may be or include a card slot which facilitates communication with the physical token through physical contact and/or a contactless reader such as a near field communication (NFC) reader which may facilitate communication with the physical token through communication protocols that do not rely on physical contact with the physical token. The CR device 1210 (FIG. 12) may then be operable to communicate transfer card data to the computing device.

At the operation 1114, the computing device sends, to the transfer rail 1010 (FIG. 12), the transfer card data. The transfer card data may be sent via a module, such as a PCI certified payment module, which may reside in the memory of the computing device. The transfer card data may be sent through a network. The transfer card data may include a value amount representing an amount of value that is to be transferred to complete a transaction and physical token data such as a primary account number (PAN) associated with a physical token.

At the operation 1120, the computing device sends, to a transfer rail 1010 (FIG. 10), the transaction information to a transfer rail 1010 (FIG. 10). The transaction information may include a plurality of receipt elements, which may include date information and time information. The transaction information may be of a text-based flat file format such as Extensible Markup Language (XML), JavaScript™ Object Notation (JSON), a delimited text file, etc.

In some embodiments, the operations 1114 and 1120 may be performed in opposite order, e.g., the operation 1120 may precede the operation 1114. In some embodiments, the operations 1114 and 1120 may be performed simultaneously.

At the operation 1130, the computing device generates a unique transaction identifier. In some examples, the unique transaction identifier may be generated using a hash function applied to the transaction information. Alternatively, in some examples, the unique transaction identifier may be generated using a unique device identifier, and/or date information and time information associated with the transaction. In some embodiments, the unique device identifier may be a unique device identifier of the computing device or the CR device 1210 (FIG. 12). In an example, the unique device identifier is a serial number, ID number,, International Mobile Equipment Identity (IMEI), or a Media Access Control (MAC) address of the computing device or the CR device 1210 (FIG. 12).

At the operation 1140, the computing device generates a unique URL. The unique URL may be based on the unique transaction identifier. The unique URL may identify a web resource corresponding to an electronic receipt of the transaction. The web resource may reside on the server 300 (FIG. 12). The unique URL may be of the form: “www.domain/unique transaction identifier/receipt elements”. The “receipt elements” of the URL may relate to the transaction information.

In some embodiments, the computing device may send the transaction information to the server via a communications module. The server 300 (FIG. 12) may then generate, at the web resource associated with the URL, a first e-receipt. In some embodiments, the computing device may be unable to communicate with the server, e.g., due to an absence of Internet connectivity. In such embodiments, the computing device may queue the transaction information to be sent to the server when communication between the computing device and the server 300 (FIG. 12) is restored.

At the operation 1150, the computing device receives, from the transfer rail, a confirmation of a successful completion of a transfer card transaction corresponding to the transaction information. The confirmation may be received via a module, such as a PCI certified payment module, which may reside in the memory of the computing device. The computing device sends, to the NFC tag controller 2070, a confirmation of the successful completion of a transfer card transaction corresponding to the transaction information. The confirmation can be contained in a NDEF message. If the transaction is declined by the transfer rail 1010, the computing device, to the NFC tag controller 2070, a denial of the transfer card transaction corresponding to the transaction information.

At the operation 1160, the computing device may send the unique URL to the NFC tag controller 2070. In some embodiments, the NFC tag controller 2070 may be integral to the CR device 1210 (FIG. 12). In some such embodiments, the computing device may send the unique URL to the CR device 1210 (FIG. 12).

Subsequent to receiving the URL, the NFC tag controller 2070 may generate an NDEF message comprising the URL as the payload. The NFC tag controller 2070 may then emit an NFC signal with the URL as the payload. In some embodiments, the CR device 1210 (FIG. 12) may emit an NFC signal with the URL as the payload.

In some embodiments, the NFC signal may be an NDEF formatted NFC Tag with the URL as the payload. Alternatively, in some embodiments, the NDEF formatted NFC Tag may be, for example, an NDEF formatted Tag with an Apple™ Universal Link URL. Alternatively, in some embodiments, the NDEF formatted NFC Tag may be, for example, an NDEF formatted Tag with an Apple™ App Clips Link URL. Alternatively, in some embodiments, the NDEF formatted NFC Tag may be, for example, an NDEF formatted Tag with an Android™ App Link URL. Alternatively, in some embodiments, the NDEF formatted NFC Tag may be, for example, an NDEF formatted Tag with an Android™ Instant Apps Link URL. Alternatively, in some embodiments, the NDEF formatted NFC Tag may be, for example, an NDEF formatted Tag with a mini-apps Link URL. In some embodiments, the payload may be a Progressive Web App based URL.

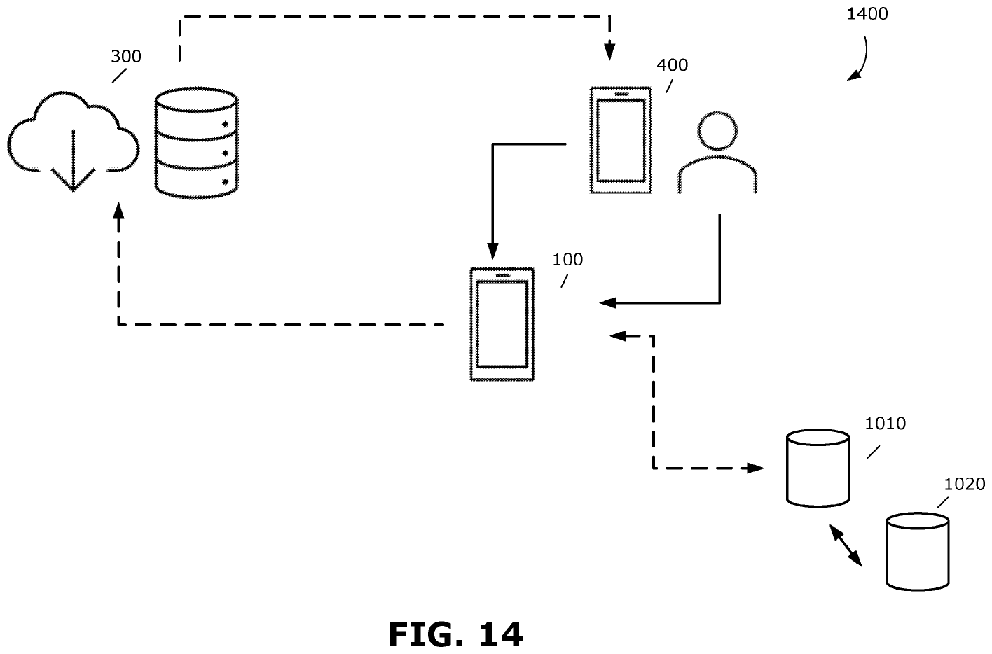

Reference is now made to FIG. 14, which is a diagram showing an e-receipt issuing computing system 1400 according to an example embodiment. Referring to FIG. 14, the e-receipt issuing computing system 1400 is shown including a computing device operating as a POS terminal 100 and including the function of the e-receipt generator 2000 (FIG. 10). The e-receipt issuing computing system is also shown including a server 300, a transfer rail 1010, an issuer computing device 1020, and a user device 400. In some embodiments, the computing device operating as a POS terminal 100 of the an e-receipt issuing computing system 1400 may be described as a PCI Contactless Payment on Commercial off-the-shelf (CPoC) device, a Mobile Payments on Commercial off-the-shelf (MPoC) device, a Tap to Phone device, and/or a Tap on phone device.

The computing device operating as a POS terminal 100, the server 300, the transfer rail 1010, the issuer computing device 1020, and the user device 400 may be in communication over a network (not shown), for example, a wireless network. In some implementations, the wireless network may be the Internet. In some implementations, the computing device operating as a POS terminal 100, the server 300, the transfer rail 1010, the issuer computing device 1020, and the user device 400 may connect to the Internet via Wi-Fi technology. The user device 400 may include an NFC tag reader. In other words, the user device 400 may include NFC Reading or a Background NFC Tag reading capability.

The computing device operating as a POS terminal 100 may be configured to operate as a physical token reader, which may be referred to an NFC tag reader. That is, the computing device operating as a POS terminal 100 may operate to read a physical token such as a transfer card or a user device 400 having a representation of a transfer card stored thereon. In this way, the computing device operating as a POS terminal 100 may be configured to receive transfer card data. The physical token reader may be a contactless card reader such as a near field communication (NFC) reader which may facilitate communication with the physical token through communication protocols that do not rely on physical contact with the physical token. The computing device operating as a POS terminal 100 may include an NFC tag controller.

The computing device operating as a POS terminal 100, which may operate to generate an e-receipt.

The computing device operating as a POS terminal 100 may communicate with the transfer rail 1010 which relays transaction data to an appropriate issuer computing device 1020. Such communication may be via a network, such as a wireless network. The transfer rail 1010 may also be referred to as a payment rail.

The computing device operating as a POS terminal 100 may be associated with an acquirer and the communication between the computing device operating as a POS terminal 100 and the transfer rail 1010 may be by way of a back-end acquirer computing device. The computing device operating as a POS terminal 100 may be located at a location that is associated with a transactor, such as a merchant. By way of example, the merchant may be a store, restaurant, gym, etc. The acquirer may be a merchant bank that accepts deposits associated with transactions made at the computing device operating as a POS terminal 100 and facilitates settlement and deposit of those deposits into an account associated with the merchant.

While a single transfer rail 1010 is illustrated in FIG. 14, in practice the POS terminal 100 and/or the e-receipt generator 2000 may communicate with multiple transfer rails. By way of example, the transfer rail 1310 may include any one or a combination of Amex™, Visa™ and/or Mastercard™. Other transfer rails may also be used. The computing device operating as a POS terminal 100 and/or a back-end acquirer computing device in communication with the computing device operating as a POS terminal 100 may, after obtaining data from a physical token, such as a value transfer card or a mobile device having a representation of a payment card which has engaged the computing device operating as a POS terminal 100, determine which of the transfer rails is to be used. For example, the POS terminal/acquirer computing device may determine that the physical token is associated with Visa™ and may, in response, select the Visa™ payment rail or it may, instead, determine that the physical token is associated with Mastercard™ and select the Mastercard™ payment rail.

After a transfer rail is identified, the computing device operating as a POS terminal 100/acquirer computing device sends the transfer rail a message. The message may be sent through a network. The message may include a value amount representing an amount of value that is to be transferred to complete a transaction and physical token data such as a primary account number (PAN) associated with a physical token. The transfer rail 1010 identifies an associated issuer based on the physical token data and communicates with the identified issuer to process the transaction. More particularly, the transfer rail 1010 routes the message received from the computing device operating as a POS terminal 100 to an issuer computing device 1020 for the identified issuer. The issuer computing device 1020 then determines whether the transaction is approved or denied based on pre-defined rules. The rules may, for example, consider any one or more of: whether the cardholder has available funds, whether the merchant is of a type that is permitted, whether the transaction violates any spending limits, etc.

When the issuer computing device 1020 determines whether to approve or deny the transaction, it sends a message indicating the result of this determination to the computing device operating as a POS terminal 100 via the transfer rail 1010. The result may then be displayed or otherwise output at the POS terminal 100.

The computing device operating as a POS terminal 100 may be referred to as a PCI CPoC device, an MPoC device, a Tap to phone device, and/or a Tap on phone device, and may include a PCI certified payment module. The computing device operating as a POS terminal 100 may be, for example, laptop, a tablet, a smart phone, or the like. In the embodiment of the e-receipt issuing computing system 1400 illustrated by FIG. 14 the computing device operating as a POS terminal 100 includes the function of the e-receipt generator 2000 (FIG. 10).

The user device 400 may include a mobile wallet that stores a representation of a payment card. A physical token may be connected to one or more accounts (such as banking accounts) that store data and/or resources accessible to the cardholder. By way of example, the physical token may be associated with a bank account and/or a credit card account. The physical token may act as a credit card or a debit card. A physical token may be used for making purchases at a point-of-sale terminal. Such physical tokens may be configured for tap-style payments in which the physical token is placed in a communication range of a physical token reader, such as the computing device operating as a POS terminal 100, to allow physical token data to be read from the physical token.

The user device 400 may be configured for near-field communication (NFC) payment processing or for wireless communication-based payment processing of another type.

The method 1300 (FIG. 13) may be performed by the e-receipt issuing computing system 1400.

It will be noted that a difference between the e-receipt issuing computing system 1400 and the e-receipt issuing computing system 1200 (FIG. 12) is that the computing device operating as a POS terminal 100 of FIG. 14 is configured to operate as a physical token reader. A physical token reader may also be described as an NFC tag reader.

As a result, in performing the method 1300 (FIG. 13), the computing device operating as a POS terminal 100 (FIG. 14), at the operation 1112 (FIG. 13), may receive transfer card data directly, rather than via a separate card reader, as described with reference to the e-receipt issuing computing system 1200 (FIG. 12).

With reference again to FIG. 13, at the operation 1130, the computing device generates a unique transaction identifier. As noted, in some examples, the unique transaction identifier may be generated using a hash function applied to the transaction information. As further noted, alternatively, in some examples, the unique transaction identifier may be generated using the unique device identifier, and/or date information and time information associated with the transaction.

At the operation 1130, the computing device operating as a POS terminal 100 (FIG. 14), may use a unique device identifier of the computing device operating as a POS terminal 100 (FIG. 14), (e.g., a unique device identifier of the PCI CPoC device, the MPC device, the Tap to phone device, and/or the Tap on phone device) as the unique device identifier.

Following the operation 1160, once the NFC signal has been emitted, it may be received by the user device 400 (FIGS. 12, 14). For example, a shopper may tap the user device 400 (FIGS. 12, 14) on the POS terminal 100 (FIGS. 12, 14), and receive the URL via the NFC signal. The user device 400 (FIGS. 12, 14) may receive the NFC signal, with the URL as a payload, via an NFC Tag reader.

Once the user device 400 (FIGS. 12, 14) receives the NFC signal, the NFC tag may launch a web browser application. The web browser application may display the web resource associated with the URL. As noted, the URL may be of the form “www.domain/unique transaction identifier/receipt elements”. The “receipt elements” of the URL may relate to the transaction information. The web resource may contain a first e-receipt.

The web resource may be launched, for example, via a Progressive Web App, via a Responsive Web App (e.g., a JavaScript™-Powered Web App), via Rich Internet App, via Single Page App, or by a Via Multi Page App.

In some embodiments, the user device 400 (FIGS. 12, 14) may include an application for the storage and display of receipts. In some such embodiments, the user device 400 (FIGS. 12, 14) may be an iOS™ Phone including an Apple™ Universal Link. In such embodiments, once the user device 400 (FIGS. 12, 14) receives the NFC signal, the Apple™ Universal Link may cause the first e-receipt to be displayed and/or stored in the application for the storage and display of receipts. In some such embodiments, the user device (FIGS. 12, 14) may not be an iOS™ Phone and may include a Deep Link (e.g. an Andriod™ App Link). In such embodiments, once the user device 400 (FIGS. 12, 14) receives the NFC signal, the Deep Link may cause the first e-receipt to be displayed and/or stored in the application for the storage and display of receipts. The first e-receipt may be displayed by the application in a format determined by the transactor associated with the transaction.

In some embodiments, the user device 400 (FIGS. 12, 14) may not include an application for the storage and display of receipts. In some such embodiments, where the user device 400 (FIGS. 12, 14) is an iOS™ Phone including an Apple™ Universal Link, the Apple™ Universal Link may direct the user to the Apple™ App Store to download an application for the storage and display of receipts. In some such embodiments, where the user device 400 (FIGS. 12, 14) is not an iOS™ Phone, the Deep Link (e.g. an Andriod™ App Link) may direct the user to ta mobile app store to download an application for the storage and display of receipts. In some such embodiments where the user device 400 (FIGS. 12, 14) is an iOS™ Phone, the user device 400 (FIGS. 12, 14) may receive an Apple™ App Clip Link and may launch an App Clip. In some such embodiments, where the user device is a non-iOS™ Phone, the user device 400 (FIGS. 12, 14) may receive an Instant App Link and may launch an Instant App. In some such embodiments, the user device 400 (FIGS. 12, 14) may receive a mini-app link and may launch a mini-app.

In some embodiments, a WebNFC framework may be used to provide one or more receipts to the user device 400 (FIGS. 12, 14).

In some embodiments, the user device 400 (FIGS. 12, 14) may launch a web

browser application rendering output at the location of the unique URL. The rendered output may comprise the first e-receipt. The format of the first e-receipt may be in a format decided by the transactor in connection with the first e-receipt. The first e-receipt may be generated using transaction data and may be displayed by the user device using an application. The application may be, for example, a Progressive Web App, a Responsive Web App (such as a JavaScript™-Powered Web App), a Rich Internet App, a Single page App, or a Multi Page App. The first e-receipt may be saved to a first location by the corresponding application. The first location may be, for example, in the memory 430 (FIG. 4) of the user device 400 (FIGS. 12, 14).

In some embodiments, as noted, the application may be launched by an Apple™ Universal Link or a relevant non-iOS™ mobile application or web application. Where the application is launched by a relevant non-iOS™ application, the application may be launched via Deep Links or by an Android™ App Link. In such embodiments, the application may display the first e-receipt in a format decided by the transactor in connection with the first e-receipt. The first e-receipt may be saved to a first location by the corresponding application. The first location may be, for example, in the memory 430 (FIG. 4) of the user device 400 (FIGS. 12, 14).

In some implementations, there may be an absence of communication between the POS terminal 100 (FIGS. 12, 14) and the server 300 (FIGS. 12, 14). In some such embodiments, the POS terminal 100 generates a URL that the user device 400 is able to generate, by parsing the URL and without accessing the URL on the Internet, a second e-receipt of the transaction. In some examples, the second e-receipt may also be used as an interim e-receipt, which is eventually replaced with the first e-receipt. For example, POS terminal 100 uploads the transaction information for the first e-receipt (or, in an alternate example, the first e-receipt itself) to the server 300 when there is Internet connectivity by the computing device 300. The server 300 associates the URL with the first e-receipt. After which, the first e-receipt can be retrieved by the user device 400. In some examples, the second e-receipt is the final receipt. For example, when there is Internet connectivity by the computing device 300, only the URL is generated in which the URL contains sufficient information such that the user device 400 is able to generate, by parsing the URL and without accessing the URL on the Internet, the second e-receipt of the transaction.

The second e-receipt may be generated by the user device 400 (FIGS. 12, 14) based on the URL received by the user device 400, for example by parsing. As noted, the URL may be of the form, “www.domain/unique transaction identifier/receipt elements”, and the “receipt elements” of the URL may relate to the transaction information. The second e-receipt may be generated by an application on the user device 400 (FIGS. 12, 14) using the information contained in the URL. The application may be, for example, an App Clip, an Instant App, or a mini-app. For example, the application may not need to be pre-installed or pre-loaded.

In some embodiments, the second e-receipt may be stored at a first location. The first location may be the memory 430 (FIG. 4) of the user device 400 (FIGS. 12, 14).

In some implementations, a user may choose to retain the second e-receipt and forego use of a first e-receipt. In some implementations, a user may refer to the second e-receipt temporarily, and may obtain and use the first e-receipt when the first e-receipt becomes available (e.g., when communication or Internet connectivity between the POS terminal 100 (FIGS. 12, 14) and the server 300 (FIGS. 12, 14) is restored). In some implementations, upon the user device 400 receiving the first e-receipt, the first e-receipt may be stored by the user device 400 at the first location. In this way, the second e-receipt, which may also be denoted as the interim e-receipt in this example, may be replaced by the first e-receipt at the first location.

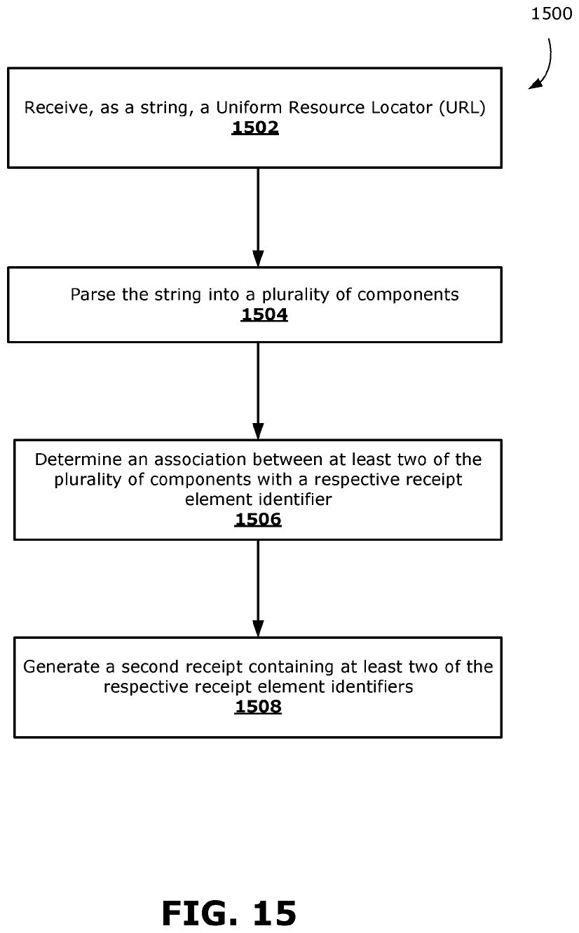

Reference is now made to FIG. 15, which is a flowchart of an example method 1500 for generating a second e-receipt, according to some embodiments. The second e-receipt may also be denoted as an interim e-receipt. The operations may be performed by the user device 400 (FIG. 1), and, more specifically, by a processor of the controller 460 (FIG. 4) of the user device 400. For example, processor-executable instructions stored in the memory 430 (FIG. 4) of the user device 400 may, when executed by one or more processors of the controller 460 (FIG. 4), configure the user device 400 to perform the example method 1300 or part thereof.

The example method 1500 of FIG. 15 may operate to instantly generate a second e-receipt, which may also be denoted as an interim e-receipt, for a transaction. The second e-receipt may be generated and displayed under a wide variety of conditions, including conditions where a user device has not been conventionally “prepared” to display an e-receipt, The example method 1500 does not require a user to pre-install an application, to register an account, to activate a user device camera and/or to exchange an email address or a phone number with an e-receipt provider, for example. The example method 1500 does not require an Internet connection at the user device.

The example method 1500 of FIG. 15 may operate to instantly generate a second e-receipt for a transaction under conditions where a user device 400 (FIG. 1) does not include a web browser application.

The example method 1500 of FIG. 15 may operate to instantly generate a second e-receipt when an Internet connection and/or a web browser application is available.

In some embodiments, the second e-receipt may be stored at a first location. The first location may be the memory 430 (FIG. 4) of the user device 400 (FIG. 1).

In some implementations, a user may choose to retain the second e-receipt and forego use of a first e-receipt. In some implementations, a user may refer to the second e-receipt temporarily, and may obtain and use the first e-receipt when the first e-receipt becomes available (e.g., when an Internet connection becomes available by the POS terminal 100). In some implementations, upon receiving the first e-receipt, the first e-receipt may be stored at the first location. In this way, the second e-receipt, which may also be denoted as the interim e-receipt in this example, may be replaced by the first e-receipt at the first location.

At the operation 1502, the user device 400 (FIG. 1) receives, as a string, a URL. For example, the URL may be of the form “www.domain/unique transaction identifier/receipt elements”. For example, an example URL may be represented by the following:
web address/unique transaction identifier/764983309-22.12.13-1107-CC-xxxxxxxx1234-KimsConvenience-26.75-3.

At the operation 1504, the user device 400 (FIG. 1) parses the string into a plurality of components representing individual receipt elements. In some embodiments, the user device 400 (FIG. 1) may parse the string into tokens in accordance with defined conventions. For example, in some implementations, after receiving the URL, the user device 400 (FIG. 1) may ignore a first group of characters, such as the characters up to and including the second forward slash. In other words, in the context of the example URL, above, the user device 400 (FIG. 1) may ignore the first group of characters “www.domain/unique transaction identifier/receipt elements”.

In some implementations, after ignoring the first group of characters, the user device 400 (FIG. 1) may split the remaining characters into a plurality of components representing individual receipt elements. For example, the user device 400 (FIG. 1) may split the remaining characters into components at each instance of a hyphen. In other words, in the context of the example URL, above, the user device 400 (FIG. 1), may split the reaming characters into the following components:
764983309;
22.12.13;
1107;
CC;
xxxxxxxx1234;
KimsConvenience;
26.75;
3.

At the operation 1506, the user device 400 (FIG. 1) determines an association between each of the plurality of components with a receipt element identifier of a plurality of receipt element identifiers. For example, in some embodiments, the user device 400 (FIG. 1) may store an ordered listing of a plurality of receipt item identifiers. In some examples, the ordered listing of a plurality of receipt element identifiers may include one or more of a receipt authorization number, a transaction date, a transaction time, a disbursement type, a disbursement amount, a number of items, a subtotal amount, a taxation amount, a discount amount, a transactor name, a transactor number, (e.g., a business number), a transactor address, a transactor phone number, or a transaction number, etc.

In some implementations, the user device 400 (FIG. 1) may determine an association between the each of the plurality of components representing individual receipt elements and a receipt element identifier of the plurality of receipt identifiers. The user device may determine the association by associating the first of the plurality of components with the first e-receipt element identifier, associating the second of the plurality of components with the second e-receipt element identifier, associating the third of the plurality of components with the third receipt element identifier, etc. However, any number of methods of determining an association between the plurality of components and the receipt element identifiers may be used, as will be understood to those skilled in the art.

In some implementations, the ordered listing of the plurality of receipt elements may include elements satisfying legal requirements for a receipt (e.g., IRS requirements).

In some implementations, the ordered listing of the plurality of receipt element identifiers may be customizable by the user. For example, in a particular implementation, the ordered listing may include a receipt authorization number, a transaction date, a transaction time, a disbursement type, a disbursement amount, a number of items, a subtotal amount, a taxation amount, a discount amount, a transactor name, a transactor number, (e.g., a business number), a transactor address, a transactor phone number, or a transaction number.

At the operation 1508, the user device 400 (FIG. 1) generates a second e-receipt containing at least two of the respective receipt element identifiers. The second e-receipt may be displayed via a graphical user interface (GUI) on the display of the user device 400. In some embodiments, the second e-receipt may include the association between the at least two of the receipt element identifiers and their respective components.

In some embodiments, the user device 400 may be operable to customize the second e-receipt.

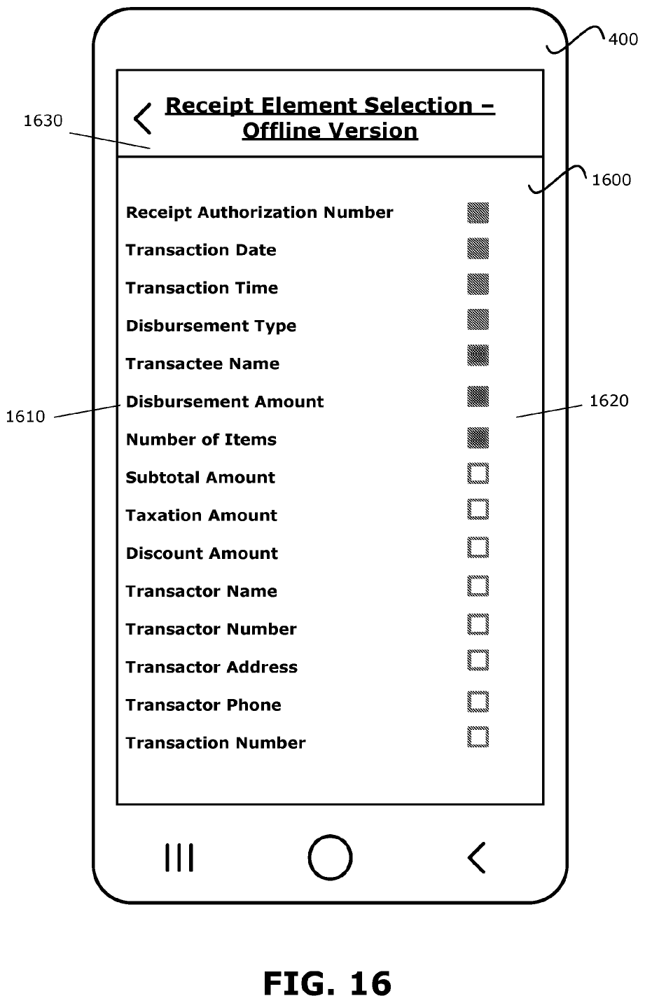

Reference is now made to FIG. 16, which illustrates an example display screen 1600 of a receipt management user interface, according to example embodiments. The receipt management user interface may be displayed on a user device 400. The example display screen 1600 includes a first heading 1630 heading, “Receipt Element Selection-Offline Version”. The example display screen 1600 further includes a first ordered listing 1610 of a plurality of receipt element identifiers. The first ordered listing 1610 of receipt element identifiers are displayed in a column on the left side of the display screen 1600. In the example of FIG. 16, the first ordered listing of receipt element identifiers are: Receipt Authorization Number; Transaction Date; Transaction Time; Disbursement Type, Disbursement Amount, Number of Items; Subtotal Amount, Taxation Amount, Discount Amount, Transactor Name, Transactor Number; Transactor Address, Transactor Phone; Transaction Number.

A set of checkboxes 1620 are displayed in a column on the right side of the display screen 1600. Each checkbox of the set of checkboxes 1620 corresponds to one of the receipt element identifiers of the first ordered listing 1610 of receipt element identifiers. In some embodiments, a user may customize the ordered listing of the plurality of receipt element identifiers by selecting the checkboxes corresponding to the desired receipt elements identifiers.

For example, FIG. 16 illustrates the first seven checkboxes highlighted, indicating a selection of the first seven corresponding receipt element identifiers. The desired receipt element identifiers of the example of FIG. 16 are as follows: Receipt Authorization Number; Transaction Date; Transaction Time; Disbursement Type, Disbursement Amount, and Number of Items. This selection may be a result of user selection, or may be a default setting. The selection of the first seven receipt element identifiers as desired receipt element identifiers may result in a display, in a corresponding interim receipt, of the desired receipt element identifiers and their associated components of the one or more plurality of components. The absence of selection of the remaining receipt element identifiers may result in the absence of a display, in a corresponding interim receipt, of the remaining receipt element identifiers and their associated components of the plurality of components.

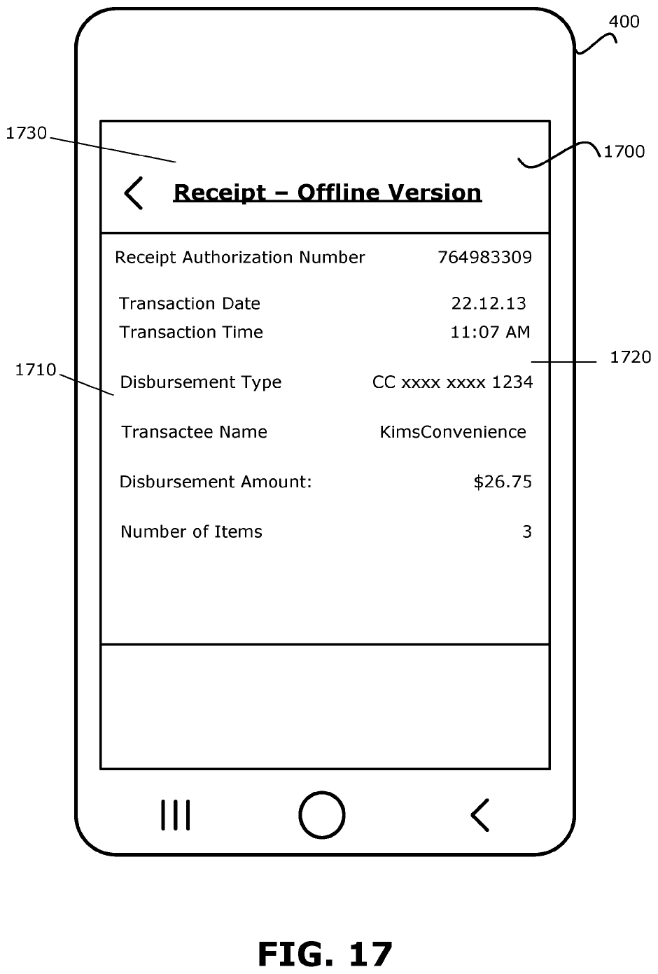

Reference is now made to FIG. 17, which illustrates an example display screen 1700 of second e-receipt, according to example embodiments. The example display screen 1700 includes a heading 1730, e.g., “Receipt-Offline Version”. The example display screen 1700 further includes a second ordered listing 1710 of a plurality of receipt element identifiers on the left side of the display screen 1700. In the example of FIG. 17, the second ordered listing of receipt element identifiers are: Receipt Authorization Number; Transaction Date; Transaction Time; Disbursement Type, Disbursement Amount, Number of Items. The second ordered listing 1710 of receipt elements corresponds to the selection of the first seven receipt element identifiers illustrated by FIG. 16.

A listing of components 1720 are displayed in a column on the right side of the display screen 1700. Each component of the listing of components 1720 is associated with one of the receipt elements of the second ordered listing 1710 of receipt elements.

The display screen 1700 of FIG. 17 illustrates the following associations between receipt element identifiers and components:
Receipt Authorization Number: 764983309
Transaction Date: 22.12.13
Transaction Time: 11:07 AM
Disbursement Type: CC xxxx xxxx 1234
Transactee Name: KimsConvenience
Disbursement Amount: $26.75
Number of Items: 3

As previously explained in connection with the operation 1506 of FIG. 15, in some implementations, the user device 400 (FIG. 1) may determine the association between the each of the plurality of components and a receipt element identifier of the plurality of receipt identifiers. The determination may be made by associating the first of the plurality of components with the first e-receipt element identifier, associating the second of the plurality of components with the second e-receipt element identifier, associating the third of the plurality of components with the third receipt element identifier, etc. However, any number of methods of determining an association between receipt element identifiers and components may be used, as will be understood to those skilled in the art.

Subsequent to generating the second e-receipt, the user device 400 (FIG. 14) may access the web resource corresponding to the first e-receipt of the transaction identified by the URL. For example, the POS terminal 100 had subsequently uploaded the transaction information for the first e-receipt (or, in an alternate example, the first e-receipt itself) to the server 300 when Internet connectivity is eventually detected (e.g., restored). In some embodiments, the first e-receipt may be stored by the user device 400 at the first location.

In some embodiments, the user device 400 (FIG. 14) may display a second e-receipt. The application may store the second e-receipt at the first location. Subsequently, the application may replace the second e-receipt with the first e-receipt by storing the first e-receipt at the first location.

In some embodiments, the user device 400 may launch a relevant mini-app mobile application to display the first e-receipt. The format of the first e-receipt may be in a format decided by the transactor in connection with the first e-receipt. The first e-receipt may be generated using transaction data. Examples of relevant mini-apps may include an Apple™ App Clip, an Android™ Instant App, etc. In examples, the mini-app is not pre-installed or pre-loaded on the user device 400.

Reference is now made to FIG. 1, which is a diagram showing an e-receipt issuing computing system 10 according to an example embodiment. Referring to FIG. 1, the e-receipt issuing computing system 10, according to an example embodiment, includes a Point of Sale (POS) terminal 100, an e-receipt generator 2000, a server 300, and a user device 400.

The POS terminal 100, the e-receipt generator 2000, the server 300, and the user device 400 may be in communication over a network (not shown), for example, a wireless network.

In some implementations, the wireless network may be the Internet. In some implementations, the POS terminal 100, the e-receipt generator, the server 300 and the user device 400 may connect to the Internet via Wi-Fi technology.

The POS terminal 100 is a device that, according to some example embodiments, may process a transaction. A transaction may correspond to one or more purchases (one or more items and/or one or more services) and a disbursement. Example embodiments may be described herein in relation to the purchases being for items, with the understanding that services would similarly apply, as well as charitable donations and goodwill. For example, a transaction may correspond to an exchange of one or more items, such as one or more goods and/or one or more services, for a disbursement amount. In some embodiments, a transaction may correspond to a purchase of one or more items. In addition to processing a transaction, the POS terminal 100 may determine a result of the transaction thereof and may manage information related to the transaction.

The POS terminal 100 may refer to one of various commercial types of POS terminal that would be known to those skilled in the art. A point of sale (POS) terminal 110 may associated with an entity (not shown), such as a merchant or acquirer.

In some embodiments, as shown, the e-receipt generator is a separate device to the POS terminal 100. In such embodiments, the POS terminal 100 and the e-receipt generator 2000 may transmit and receive data through a communication computing device. For example, the communication computing device may include a wired communication computing device through a Universal Serial Bus (USB) cable or a wireless communication computing device such as Wi-Fi or Bluetooth. However, example embodiments are not limited thereto.

In some embodiments, the POS terminal 100 and the e-receipt generator 2000 may reside on the same device.

In some embodiments, although FIG. 1 illustrates the POS terminal 100 as a single device, the example embodiments are not limited thereto, and the POS terminal 100 may comprise a plurality of devices. The plurality of devices may be in communication with the e-receipt generator 2000.

The e-receipt generator 2000 is a medium that allows a consumer to check an e-receipt with a smartphone. The e-receipt generator 2000 may transmit data to and/or exchange data with the user device 400 using NFC wireless connectivity technologies. According to an embodiment, the e-receipt generator 2000 may generate or include an NFC tag and may communicate using an NFC standard. However, the example embodiments are not limited thereto, and the e-receipt generator 2000 may, additionally or alternatively, use standards such as Bluetooth, Radio Frequency Identification (RFID), Magnetic Secure Transmission (MST), Beacon, Zigbee, etc.

The e-receipt generator 2000 may communicate with the server 300 through a communication network (not shown). In some implementations, the communication network may be the Internet, such that the e-receipt generator 2000 may communicate with server 300 to transmit and receive data via the Internet. However, the example embodiments are not limited thereto. In some implementations, the e-receipt generator 2000 may communicate with the server 300 by connecting to the Internet through Wi-Fi, but the example embodiments are not limited thereto.

The server 300 may be a dedicated server or a cloud server, for example. However, the example embodiments are not limited thereto.

The server 300 may be connected to the e-receipt generator 2000 through a communication network (not shown). The server may receive data from the e-receipt generator 2000, and may store the data in a database. The server 300 may be connected to the user device 400 through a communication network (not shown) and may thus transmit data to the user device 400. Here, the communication network may be the Internet, but the example embodiments are not limited thereto. The user device 400 may access the server 300 by accessing the Internet through Wi-Fi or a through a mobile network, however, the example embodiments are not limited thereto.

The user device 400 is a device through which a user, who is the subject of a transaction, may check an e-receipt. The user device 400 may include a smartphone, a smart watch, a smart device, a personal digital assistant (PDA), a wireless communication terminal, wearable technology (e.g., smartwatch. smartglasses) etc. However, the example embodiments are not limited thereto.

The user device 400 is a device that supports NFC technology to wirelessly communicate with the e-receipt generator 2000. According to an embodiment, the user device 400 may support the NFC standard. However, the example embodiments are not limited thereto, and additionally or alternatively, the user device 400 may support standards such as Bluetooth, Radio Frequency Identification (RFID), Magnetic Secure Transmission (MST), Beacon, Zigbee, etc.

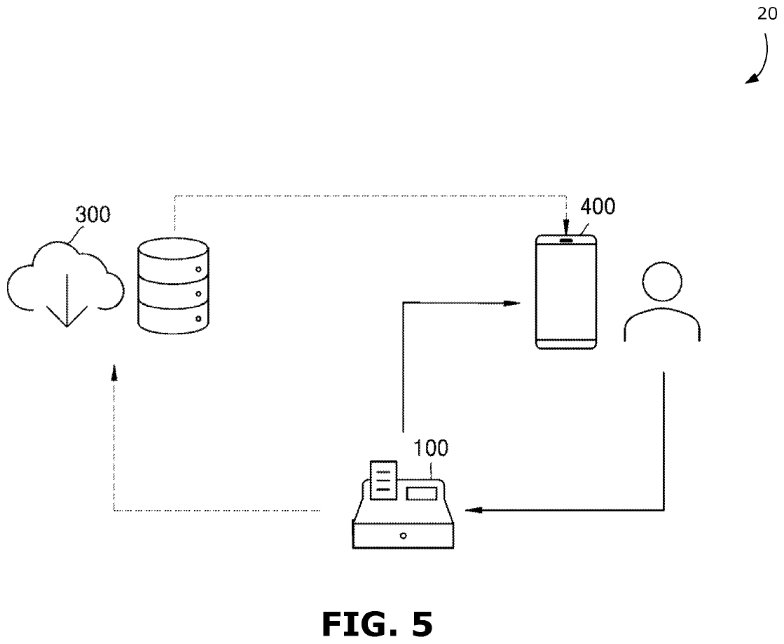

Reference is now made to FIG. 5, which is a diagram showing an e-receipt issuing computing system 20 according to an example embodiment. Referring to FIG. 5, the e-receipt issuing computing system 20 is shown including a POS terminal 100, a server 300, and a user device 400. In the embodiment of the e-receipt issuing computing system 20 illustrated by FIG. 5, the POS terminal 100 includes the function of the e-receipt generator 2000 (FIG. 1).

The e-receipt issuing computing system 20 of FIG. 5 is similar to the e-receipt issuing computing system 10 of FIG. 1. However, according to the embodiment of FIG. 5, the e-receipt generator is not implemented as a separate device, but is rather implemented in the form of a computer program recorded on a recording medium that may be read by a POS terminal. In some implementations, the e-receipt generator is implemented in the form of one or more applications stored in the memory of the POS device. Therefore, according to the embodiment of FIG. 5, the POS terminal 100 includes the function of an e-receipt generator.

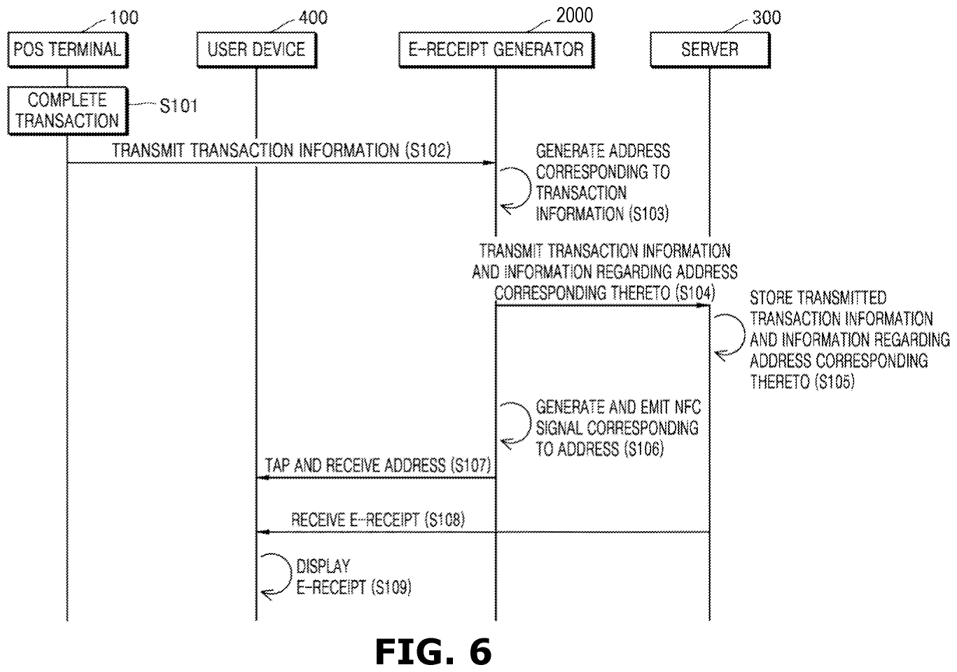

FIG. 6 is a diagram showing a method of issuing an e-receipt according to an example embodiment. Referring to FIG. 6, at the operation 101, a user completes a transaction. In some embodiments, completion of a transaction refers to a state in which all user selected items have been scanned by the POS terminal 100, discounts and purchase points have been applied as appropriate, and disbursements for the selected items have been received via a payment method.

In some embodiments, as a transaction is completed, the POS terminal 100 obtains transaction information. Transaction information may be a set of all information respecting a transaction for which disbursements have been received. For example, transaction information may include a transaction date and a transaction time, an identification of one or more items corresponding to the transaction (e.g., the names of one or more goods and/or services), a disbursement amount in connection with each of the one or more items, a disbursement amount in connection with all of the one or more items, a quantity of the one or more items, a total disbursement amount, a taxation amount, a disbursement type (e.g., information regarding a transaction method, such as credit card information and/or debit card information), a receipt authorization number, a discount amount, a transactor name, a transactor number, (e.g., a business number), a transactor address, a transactor phone number, a transaction number, etc. However, the example embodiments are not limited thereto.

In some embodiments, transaction information may be data, and may be recorded, for example, in a text (TXT) file format, and may include some or all of the above-recited transaction information. In some embodiments, the format of the transaction information may include a Rich Text Format (RTF) file format, an Extensible Markup Language (XML) file format, a JavaScript™ Object Notation (JSON) file format, a Comma-Separated Values (CSV) file format, and/or a Tab-Separated Values (TSV) file format. However, the example embodiments are not limited thereto.

At the operation 102, the POS terminal 100 transmits transaction information to the e-receipt generator 2000.

Referring again to FIG. 1, in some embodiments, the POS terminal 100 transmits transaction information to the e-receipt generator 2000 by a wired communication method or a wireless communication method.

Referring again to FIG. 5, in some embodiments where the POS terminal and the e-receipt generator are integrated, transaction information is transmitted internally.

Returning again to FIG. 6, at the operation 103, the e-receipt generator 2000 generates an address corresponding to received transaction information.

In some embodiments, the address refers to a URL for accessing a web site or a web page on the Internet, although the example embodiments are not limited thereto.

In some embodiments, the e-receipt generator 2000 may generate a unique address corresponding to each transaction. Generating a unique address corresponding to each transaction may avoid clashes that may occur when the same address corresponds to more than one transaction. In some embodiments, the e-receipt generator 2000 may generate a unique address by including, in the unique address, a unique transaction identifier corresponding to the particular, corresponding transaction. For example, in some implementations, an address may be a URL and may have the format “web address/identifier.” In such implementations, the format of the identifier may have various lengths based on a combination of letters, numbers, and special characters, but the example embodiments are not limited thereto.

According to an embodiment, the e-receipt generator 2000 may generate an identifier corresponding to a transaction based on the transaction information associated with the transaction. For example, an identifier may be generated based on information respecting the e-receipt generator 2000 and/or on a transaction date and a transaction time. According to a further example, the e-receipt generator 2000 may generate an identifier using a hash technique. A hash technique is a technique for obtaining one result value corresponding to one input value using a hash function. In such examples, an identifier may be a result value obtained using transaction information as an input value to the hash function.

According to an example embodiment, by using an identifier when generating an address (e.g., a URL) and by subsequently transmitting the address to the user device 400 via NFC, the following points may be ensured. In examples, the issuance of a particular e-receipt to only one user may be guaranteed. The particular e-receipt ensures one-to-one uniqueness of the e-receipt based on the use of the (unique) identifier or a hash thereof. In some examples, the particular e-receipt is deleted by the server 300 after retrieval by the user device 400.

In examples, as a result, the address (URL) may be guaranteed to be visited by only one user device 400, e.g., by one user. Should another user attempt to subsequently access the same address (URL), the address will no longer be functional, and thus personal privacy and security of a user may be maintained.

At the operation 104, the e-receipt generator 2000 transmits transaction information and corresponding address information to the server 300. The e-receipt generator may also transmit the corresponding unique transaction identifier to the server 300.

In some embodiments, the e-receipt generator 2000 may transmit transaction information; an entire address corresponding thereto, including an identifier included in the address; other information indicating an address; a unique transaction identifier corresponding to the transaction, and other information indicating an identifier, etc. to the server 300, but the example embodiments are not limited thereto.

At the operation 105, the server 300 stores the transaction information and information regarding the address corresponding thereto, which have been received from the e-receipt generator 2000. The server 300 may also store the corresponding unique transaction identifier.

At the operations 104 and 105, the e-receipt generator 2000 transmits transaction information and information regarding an address corresponding thereto to the server 300. The server 300 then stores this information. Thereafter, a user may view, via the user device, a corresponding e-receipt, including corresponding transaction information, on a web page corresponding to the address. According to an example embodiment, since an e-receipt is viewed on a web page using a standard web browser application, a user does not need to install an additional mobile application on the user device in order to view the e-receipt.

At the operation 106, the e-receipt generator 2000 generates an NFC signal corresponding to the address.

In some embodiments, the e-receipt generator 2000 may transmit information to the user device 400 using NFC technology. In some an embodiments, the e-receipt generator 2000 may generate and emit a message in a particular format used for NFC. In some implementations, the particular format may refer to a format that enables the user device 400 to receive a corresponding message including an instruction to immediately perform a predetermined action. For example, the e-receipt generator 2000 may generate and emit an NDEF message. The NDEF message may include information to be transmitted to the user device 400. The NDEF message may include the address as a payload. Thereafter, the user device 400 may perform a predetermined operation upon receiving the NDEF message. The predetermined operation may be, for example, to open a particular web page using a web browser application. The web page may be linked to the address.

Although FIG. 6 illustrates the operation 106 as occurring after the operation 105, example embodiments are not limited to this sequence of events. For example, in some embodiments, the operation 105 and the operation 106 may occur contemporaneously. As a further example, in some embodiments, the operation 105 may occur after the operation 106.

At the operation 107, the user device 400 receives the address by tapping the e-receipt generator 200.

In some embodiments, the user device 400 may receive information from the e-receipt generator 2000 through NFC. The user device 400 may include a device, an application, and/or an API that supports, or helps to support, the NFC function. In some embodiments, the user device 400, by approaching the e-receipt generator 2000 within dozens of centimeters, may receive an NDEF message including the address as a payload.

At the operation 107, as the e-receipt generator 2000 transmits the address to the user device 400 through NFC, the user device 400 may obtain information respecting an e-receipt through a simple and quick action of tapping the e-receipt generator 200. In such embodiments, it may not be necessary to input personal information to the POS terminal 100 to obtain the e-receipt.

At the operations 108 and 109, the user device 400 accesses a designated web page based on a received address and displays an e-receipt.

In some embodiments, the user device 400 may access, on the Internet, a web page linked to the received address. The user device 400 may receive the address via the NDEF message and may automatically access, as a predetermined action, a web page linked to the address. The server 300 may already store transaction information corresponding to the address. The server 300 may generate an e-receipt by converting the transaction information into an e-receipt format through a specialized application. The server 300 may display the generated e-receipt on a web page linked to the address. As a result, a user may view the e-receipt by accessing the web page linked to the address via the user device 400.

In an example, the user device 400, upon receipt of the NFC signal, immediately displays the e-receipt through a web page corresponding to the web page URL or an application page without using an e-mail address, a text message, or an execution of a pre-loaded or pre-installed application. In an example, the user device 400 does not need to have pre-installed or pre-loaded an application. For example, the user device 400 can use e.g., a native browser, Progressive Web Apps (PWAs), or mini-apps, etc. Mini-apps are further described below.

In examples, the user device 400 is not required to have been “prepared” to receive and display the e-receipt. For example, the user device 400 can operate without having to pre-download, pre-install or pre-load an application. For example, the user device 400 can operate without having to activate a camera to scan QR code, exchange email address or phone number. Rather, the mini-app can be loaded as part of the NFC proximity between the user device 400 and the NFC tag controller 2070.

An e-receipt may be generated by various types of applications, such as a Progressive Web Application, a Responsive Web Application, a Rich Internet Application, a Single Page Application, or a Multi Page Application, although the example embodiments are not limited thereto.

An e-receipt is a type of electronic document in which transaction information is displayed based on a set of rules according to a format determined by a provider. The provider may be the transactor in connection with the e-receipt. For example, the provider may be a merchant or a retailer, although the example embodiments are not limited thereto. The provider is distinct from the transactee, a consumer, a user, or a customer.

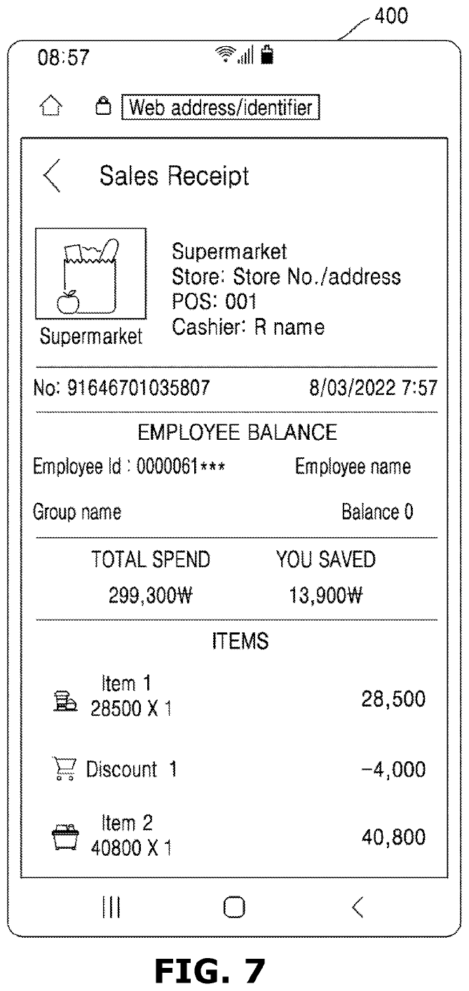

FIG. 7 illustrates an example e-receipt according to an example embodiment. As shown in FIG. 7, an e-receipt may be displayed on a web page via a web browser application. In some embodiments, the e-receipt may include a transaction date and a transaction time, an identification of one or more items associated with the transaction (e.g., the names of one or more goods and/or services associated with the transaction), a disbursement amount in connection with each of the one or more items, a quantity of the one or more items, a total disbursement amount, a taxation amount, a disbursement type (e.g., information regarding a transaction method, such as credit card information and/or debit card information), a receipt authorization number, a transactor name, a transactor number, (e.g., a business number), a transactor address, a transactor phone number, a transaction number, etc. As noted, the format of an e-receipt may be determined by a provider and is not limited to that shown in the drawings.

In some embodiments, a transactee and/or a user may view an e-receipt via a user device without installing a particular, specialized application on the user device. Conventionally, the viewing of e-receipts via a user device often requires that a particular, specialized application be installed on the user device. It is also often necessary to complete a login process via the user device in order to view the e-receipt. However, the example embodiments include computing devices and methods for viewing an e-receipt on a web page through a conventional web browser application, without requiring the installation of a particular, specialized application, registration at any website, or the completion of any login process.

In some embodiments, a consumer may check an e-receipt on a user device via the simple action of tapping an e-receipt generator. Since a URL may thus be transmitted to the user device through an NDEF message according to example embodiments, the user device may directly execute the URL using a pre-set command in the NDEF message. In this way, the user may view the e-receipt through a web browser application as a result of a simple tapping action and without any further action.

In some embodiments, a consumer may be provided with an e-receipt via a user device without providing personal information such as an e-mail or a phone number. As a result, according to example embodiments, unnecessary leakage of personal information during a transaction process may be prevented, the procedure and the time until issuance of an e-receipt may be shortened, and an e-receipt may be more conveniently viewed on a user device.

In some embodiments, a user may be provided with an e-receipt through a user device regardless of the corresponding transaction type. For example, conventionally, when a credit card company issues an e-receipt, the e-receipt may be received only when disbursements are provided using a credit card associated with the corresponding credit card company. However, according to example embodiments, since an e-receipt may be issued to a user device in conjunction with the POS terminal associated with the transaction, a user may receive an e-receipt regardless of the transaction type, which may include cash, debit card, credit card, digital wallet, etc.

In some embodiments, a user may be provided with an e-receipt including a plurality of transaction information. Conventionally, when an e-receipt is issued through a related application or a short message service (SMS) after a transaction, only limited transaction information may be displayed on the e-receipt. For example, in some conventional situations, only a total disbursement amount is displayed, and detailed transaction information (e.g., an identification of one or more items related to the transaction, the quantity of the one or more items, the disbursement amount associated with each item, the taxation amount, etc.) are not displayed. In contrast, however, according to embodiments described herein, a user may be provided with an e-receipt including a plurality of transaction information.

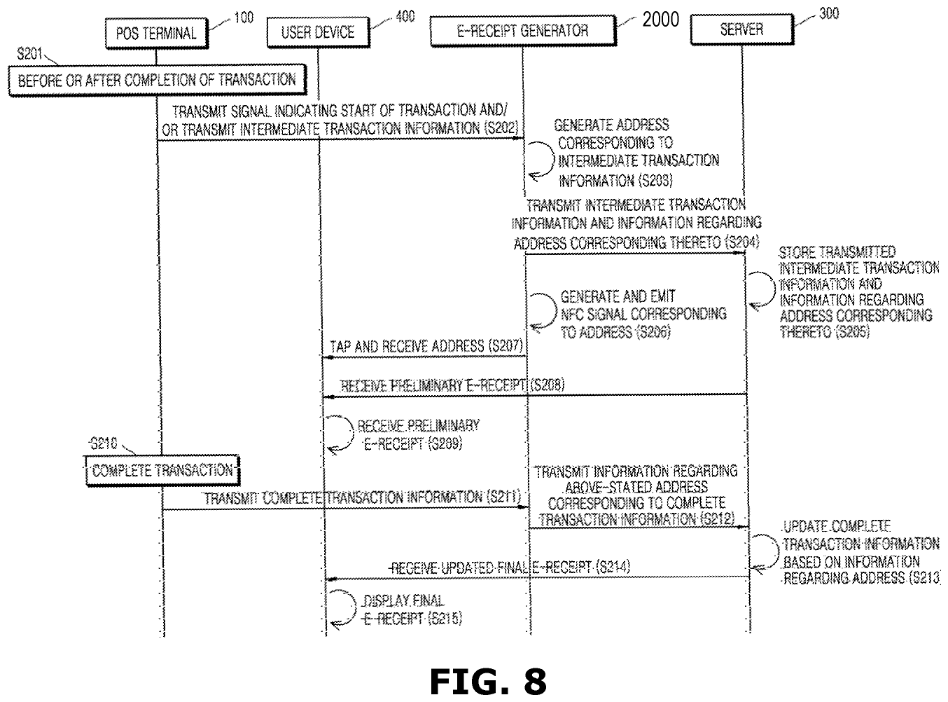

FIG. 8 illustrates a method of issuing an e-receipt according to another example embodiment. Referring to FIG. 8, at the operation 201, a user has yet to begin a transaction or the user has started at least a part of a transaction.

In contrast to the method illustrated in FIG. 5, at the beginning of the method of FIG. 8, (e.g., at the operation 201), the transaction has not yet been completed. At the operation 201, the user has yet to provide disbursement for the one or more items associated with the transaction. For example, the operation 201 may correspond to a time prior to the scanning of a first item at a POS terminal, a time at which at least one item has been scanned to the POS terminal, or a time at which, although all items have been scanned to the POS terminal, disbursement has not yet been provided.

At the operation 202, the POS terminal 100 transmits transaction information to the e-receipt generator 200.

In some embodiments where the POS terminal and the e-receipt generator are separate devices, as illustrated by FIG. 1, the POS terminal 100 may transmit intermediate transaction information to the e-receipt generator 2000 via a wired communication method or via a wireless communication method. In some embodiments where the POS terminal and the e-receipt generator are integrated within the same device, as illustrated by FIG. 5, transaction information may be transmitted internally.

In some embodiments, intermediate transaction information is distinguished from

completed transaction information. For example, the intermediate transaction information may be a set of all information respecting a transaction for which disbursements have yet to be received. For example, the intermediate transaction information may include a transaction date and a transaction time, an identification of one or more items corresponding to the transaction, a disbursement amount associated with each of the one or more items, a quantity of the one or more items, a subtotal amount, a transactor name, a transactor number, a transactor address, a transactor phone number, etc. However, the intermediate transaction information may not include a total disbursement amount, a disbursement type, a promotional amount associated with the transaction, a discount amount, and a total disbursement amount reflecting the discount amount, etc.

In some embodiments, temporary transaction information may be data stored in a certain format. For example, preliminary transaction information may be data in which records the above-recited transaction information in a text file format, for example.

At the operation 203, the e-receipt generator 2000 generates an address corresponding to received intermediate transaction information.

In some embodiments, an address may refer to a URL for accessing a web site or a web page on the Internet, although the example embodiments are not limited thereto.

In some embodiments, the e-receipt generator 2000 may generate a unique address corresponding to intermediate transaction information. As a result, address clashing, such as may occur when the same address is generated in response to different transaction information, may be avoided. The e-receipt generator 2000 may generate a unique address by including a unique transaction identifier corresponding to the intermediate transaction information in an address. For example, an address may have the format “web address/identifier.” In such examples, the format of the identifier may have various lengths based on a combination of letters, numbers, and special characters, although the example embodiments are not limited thereto.

In some embodiments, the e-receipt generator 2000 may generate an identifier based on the intermediate transaction information. For example, an identifier may be generated based on information respecting the e-receipt generator 2000 and a transaction date and a transaction time that the transaction information is generated. In some embodiments, the e-receipt generator 2000 may generate an identifier using a hash technique. In such embodiments, the hash technique may be a technique for obtaining one result value corresponding to one input value using a hash function. In such embodiments, an identifier may be a result value obtained through the hash function using intermediate transaction information as an input value.

At the operation 204, the e-receipt generator 2000 transmits intermediate transaction information and information regarding an address corresponding thereto to the server 300.

In some embodiments, the e-receipt generator 2000 may transmit intermediate transaction information, an entire address, including an identifier, corresponding thereto, other information related to the address, and other information related to the identifier, etc. to the server 300, although the example embodiments are not limited thereto.

At the operation 205, the server 300 stores the intermediate transaction information and information respecting the corresponding address, which are received from the e-receipt generator 200.

At the operation 206, the e-receipt generator 2000 generates an NFC signal corresponding to the address.

In some embodiments, the e-receipt generator 2000 may transmit information to the user device 400 via NFC. In some embodiments, the e-receipt generator 2000 may generate and emit a message in a particular format used for NFC. The particular format may refer to a format that enables the user device 400 receiving a corresponding message to immediately perform a predetermined action. For example, the e-receipt generator 2000 may generate and emit an NDEF message. The NDEF message may include information to be transmitted to the user device 400. The NDEF message may include, as a payload, an address. Thereafter, the user device 400 may perform a predetermined operation upon receiving the NDEF message.

Although FIG. 8 shows that operation 206 occurs after operation 205, the example embodiments are not limited thereto. For example, operation 205 and operation 206 may occur contemporaneously or operation 205 may occur after operation 206.

At the operation 207, the user device 400 receives the address by tapping the e-receipt generator 200.

In some embodiments, the user device 400 receives information from the e-receipt generator 2000 via NFC. The user device 400 may include a device, an application, and/or an application programming interface (API) that supports or helps to support the NFC function. In some embodiments, the user device 400 may receive an NDEF message including the address as a payload by approaching the e-receipt generator 2000 within dozens of centimeters.

At the operations 208 and 209, the user device 400 accesses a designated web page

based on a received address and displays a preliminary e-receipt.

In some embodiments, the user device 400 may access a web page on the Internet linked to the received address. In some embodiments, the server 300 may already store intermediate transaction information corresponding to the address. The server 300 may then convert the intermediate transaction information into a preliminary e-receipt format using an application. The server 300 may then display a generated preliminary e-receipt on a web page linked to the address. As a result, the user device 400 may view the preliminary e-receipt by accessing the web page linked to the address.

In some implementations, the preliminary e-receipt may be generated using various one or more applications, such as by using a Progressive Web Application, a Responsive Web Application, a Rich Internet Application, a Single Page Application, and/or a Multi Page Application, although the example embodiments are not limited thereto.

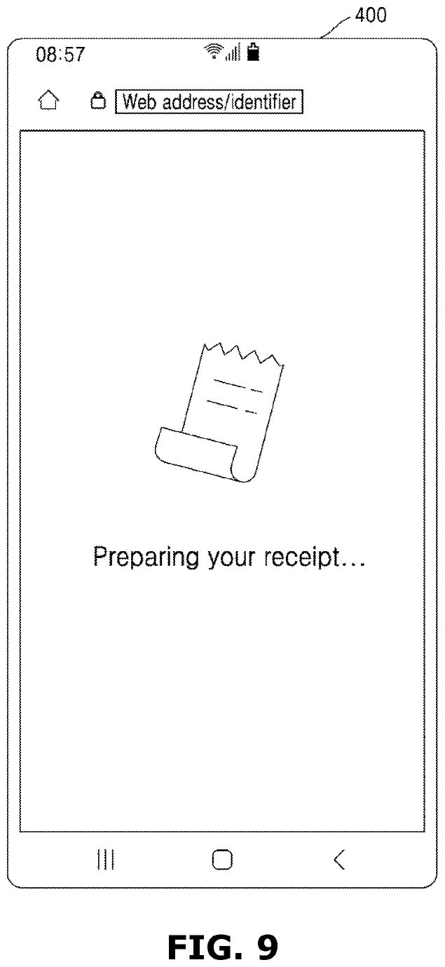

In some embodiments, as shown in FIG. 9, the user device 400 may not display a preliminary e-receipt and may instead display a message such as, “Preparing your receipt.”

Returning again to FIG. 8, at the operation 210, the user completes the transaction. In some embodiments, as the transaction is completed, the POS terminal 100 may obtain completed transaction information. In some embodiments, the completed transaction information may be a plurality of information respecting a transaction for which disbursements have been received.

In some embodiments, in addition to a transaction date and a transaction time, an identification of one or more items associated with the transaction, a disbursement amount associated with each of the one or more items, a quantity of the one or more items, a transactor name, a transactor number, a transactor address, a transactor phone number, etc., the completed transaction information may further include a final disbursement amount, a final taxation amount, and/or information regarding a disbursement type, etc.

In some embodiments, the completed transaction information may include a plurality of information respecting a transaction in which disbursements have been received after a discount amount and/or a promotional amount has been applied. In such embodiments, the completed transaction information may include membership information, promotional information and amounts, discount information and amounts, a final disbursement amount in which the discount amount is reflected, etc., in addition to the other above-recited information.

In some embodiments, similar to preliminary transaction information, completed transaction information may be data stored in a certain format. For example, completed transaction information may be data in which the above-recited information is recorded in a text file format.

At the operation 211, the POS terminal 100 transmits completed transaction information to the e-receipt generator 200.

Referring again to FIG. 1, in some embodiments, the POS terminal 100 may transmit transaction information to the e-receipt generator 2000 via a wired communication method or via a wireless communication method. In embodiments where the POS terminal and the e-receipt issuer are integrated with each other, such as that illustrated by FIG. 5, transaction information is transmitted internally.

Referring again to FIG. 8, at the operation 212, the e-receipt generator 2000 transmits completed transaction information and information regarding an address corresponding thereto to the server 300.

In some embodiments, the e-receipt generator 2000 already has intermediate transaction information and an address corresponding thereto. In some such embodiments, the intermediate transaction information may be replaced or updated by the completed transaction information. As a result, the e-receipt generator 2000 may use the address corresponding to the intermediate transaction information as the address corresponding to the completed transaction information. As a result, address clashing may be avoided. The e-receipt generator 2000 may transmit completed transaction information, an entire address already stored therein, an identifier included in the address, other information indicating an address, and other information indicating an identifier, etc. to the server 300, although the example embodiments are not limited thereto.

At the operation 213, the server 300 updates the intermediate transaction information as completed transaction information using information respecting the address transmitted from the e-receipt generator 200.

At the operations 214 and 215, the user device 400 accesses a designated web page based on a received address and displays an updated e-receipt.

In some embodiments, the user device 400 may access a web page on the Internet linked to the received address. The server 300 may already store updated completed transaction information corresponding to the address. The server 300 may convert the completed transaction information into an e-receipt format using an application. The server 300 may then display a generated updated e-receipt on a web page linked to the address. As a result, the updated e-receipt may be viewed by accessing the web page linked to the address via the user device 400.

In some embodiments, the updated e-receipt may be generated by one or more applications, such as a Progressive Web Application, a Responsive Web Application, a Rich Internet Application, a Single Page Application, or a Multi Page Application, although the example embodiments are not limited thereto.

In some embodiments, such as those illustrated by FIG. 6, a user may view an e-receipt by tapping a user device on an e-receipt generator after a transaction is completed. In some embodiments, such as those illustrated by FIG. 8, even before a transaction is completed, a user device may receive an address of a related web page by tapping an e-receipt generator, and, after the transaction is completed, the final e-receipt may be automatically updated to allow viewing of the updated e-receipt via the user device.

Some example embodiments may vary from those described with reference to FIGS. 6 and 8.

For example, at the operation 103 of FIG. 6 and at the operation 203 of FIG. 8, the e-receipt generator 2000 may generate an address corresponding to received transaction information. The address may refer to a URL for accessing a web site or a web page on the Internet.

In some embodiments, however, the address may refer to a deep link URL for directly accessing a mobile application page or a web application page.

In some such embodiments, a deep link URL may be directly generated by the e-receipt generator 2000 in response to receiving transaction information. However, the example embodiments are not limited thereto, and the e-receipt generator 2000 may first generate a URL in response to receiving transaction information and subsequently derive a deep link URL therefrom.

In some embodiments, at the operations 108 and 109 of FIG. 6, and at the operations 214 and 215 of FIG. 8, the user device 400 accesses a designated web page based on a received address and displays an e-receipt.

In some embodiments where the address in a deep link URL, the user device 400 may directly accesses a designated mobile application page or a designated web application page based on a received address and may subsequently display an e-receipt. For example, the user device 400 may execute an application and may access a mobile application page or a web application page linked to a received address. The user device 400 may receive an address via an NDEF message and, as a predetermined action, may execute a related application and may access a web page linked to the address.

In some embodiments, when a related application has yet to be installed on the user device 400, the user device 400 may install a related application and then may then access a mobile application page or a web application page linked to the address. In some such embodiments, the user device 400 may receive the address through an NDEF message and, as a predetermined action, may install a related application and may access a page linked to the address.

In example embodiment, unless explicitly described to the contrary, the word “comprise” and variations such as “comprises” or “comprising” will be understood to imply the inclusion of stated elements but not the exclusion of any other elements.

In example embodiments, a “module” may be a hardware component such as a processor or a circuit, and/or a software component executed on the hardware, such as, for example, a processor.

In example embodiments, each of components, functional blocks, or means may include one or more sub-components. Electrical, electronic, and mechanical functions performed by the components may be implemented by various well-known devices or mechanical elements, such as electronic circuits, integrated circuits, application specific integrated circuits (ASICs), etc. and may be implemented separately from one another or integrally implemented in combination of two or more thereof.

The modules described as separate parts may or may not be physically separate, and parts displayed as modules may or may not be physical modules, may be located in one position, or may be distributed on a plurality of network modules. Some or all of the modules may be selected according to actual requirements to achieve the objectives of the solutions of the embodiments.

In addition, functional modules in the example embodiments may be integrated into one processing module, or each of the modules may exist alone physically, or two or more modules are integrated into one module.

When the functions are implemented in the form of a software functional module and sold or used as an independent product, the functions may be stored in a computer-readable storage medium (which can be non-transitory). Based on such an understanding, the technical solutions of example embodiments may be implemented in a form of a software product. The software product is stored in a storage medium, and includes several instructions for instructing a computer device (which may be a personal computer, a server, or a network device) to perform all or some of the steps of the methods described in the example embodiments. The foregoing storage medium includes any medium that can store program code, such as a Universal Serial Bus (USB) flash drive, a removable hard disk, a read-only memory (Read-Only Memory, ROM), a random access memory (Random Access Memory, RAM), a magnetic disk, or an optical disc.

In the described methods or block diagrams, the boxes may represent events, steps, functions, processes, modules, messages, and/or state-based operations, etc. While some of the example embodiments have been described as occurring in a particular order, some of the steps or processes may be performed in a different order provided that the result of the changed order of any given step will not prevent or impair the occurrence of subsequent steps. Furthermore, some of the messages or steps described may be removed or combined in other embodiments, and some of the messages or steps described herein may be separated into a number of sub-messages or sub-steps in other embodiments. Even further, some or all of the steps may be repeated, as necessary. Elements described as methods or steps similarly apply to computing devices or subcomponents, and vice-versa. Reference to such words as “sending” or “receiving” could be interchanged depending on the perspective of the particular device.

The described embodiments are considered illustrative and not restrictive. Example embodiments described as methods would similarly apply to computing devices or devices, and vice-versa.

The various example embodiments are merely examples and are in no way meant to limit the scope of the examples and example embodiments. Variations of the innovations described herein will be apparent to persons of ordinary skill in the art, such variations being within the intended scope. In particular, features from one or more of the example embodiments may be selected to create alternative embodiments comprises of a sub-combination of features which may not be explicitly described. In addition, features from one or more of the described example embodiments may be selected and combined to create alternative example embodiments comprised of a combination of features which may not be explicitly described. Features suitable for such combinations and sub-combinations would be readily apparent to persons skilled in the art upon. The subject matter described herein intends to cover all suitable changes in technology.

1-33. (canceled)

34. A computing device comprising:
a communications module;
a processor; and
at least one memory coupled to the processor, and storing instructions which, when executed by the processor, cause the processor to:
receive transaction information corresponding to a transaction, the transaction including one or more purchases and a disbursement, the transaction information including a plurality of receipt elements;
send, to a transfer rail, the transaction information;
generate, using the transaction information: a unique transaction identifier;
generate a uniform resource locator (URL) which includes the unique transaction identifier;
receive, from the transfer rail, a confirmation of a successful completion of a transfer card transaction corresponding to the transaction information; and
send, to an NFC tag controller, an NFC data exchange format (NDEF) message comprising a string containing the URL as a payload,
wherein the computing device is a Payment Card Industry (PCI) certified payment device.

35. The computing device of claim 34, wherein the processor is further caused to, prior to the sending, to the NFC tag controller, the URL:
send, to the NFC controller, the confirmation of the successful completion of the transfer card transaction corresponding to the transaction information.

36. The computing device of claim 34, wherein the URL further includes at least some of the plurality of receipt elements including a transactor name, a transaction date, an identification of the one or more purchases, or a total disbursement amount.

37. The computing device of claim 366, wherein the processor is further caused to determine an absence of Internet connectivity at the computing device;
wherein the sending includes sending, via the NFC tag controller, the URL to a user device;
wherein the URL includes the at least some of the plurality of receipt elements so that the user device is able to generate, by parsing the URL and without accessing the URL on the Internet, a receipt of the transaction.

38. The computing device of claim 34, wherein the unique transaction identifier is generated by using a hash function on the transaction information.

39. The computing device of claim 38, wherein the transaction information includes a unique identifier of the computing device, and wherein the hash function is applied to the unique identifier.

40. The computing device of claim 38, wherein the computing device is a PIN Transaction Service Point of Interaction (PTS POI) device, wherein the transaction information includes a unique identifier of the PTS POI device, wherein the hash function is applied to the unique identifier.

41. The computing device of claim 34, wherein the processor is further caused to, prior to the receiving a confirmation of a successful completion of a transfer card transaction:
determine an absence of Internet connectivity at the computing device.

42. The computing device of claim 34, wherein the processor is further caused to, prior to the receiving the confirmation of the successful completion of the transfer card transaction corresponding to the transaction information:
send, via the communications module, to a server, the transaction information and the URL,
wherein the URL identifies a web resource corresponding to a receipt of the transaction.

43. The computing device of claim 34, wherein the URL identifies a web resource corresponding to a receipt of the transaction, wherein the web resource links to a web page or an app page for accessing by a user device of a receipt of the transaction.

44. The computing device of claim 34, wherein the processor is further caused to, prior to the sending, to the transfer rail, the transaction information:
receive transfer card data; and
send, to the transfer rail, the transfer card data.

45. The computing device of claim 44, wherein the receiving of the transfer card data is received from a card reader (CR) device of the computing device, wherein the CR device comprises the NFC tag controller, wherein the URL further includes a unique device identifier, wherein the unique device identifier is of the CR device.

46. The computing device of claim 34, further comprising:
the NFC tag controller,
wherein the processor is configured to cause the NFC tag controller to:
generate and emit, via the NFC tag controller, the NFC data exchange format (NDEF) message.

47. The computing device of claim 34, further comprising:
an NFC tag reader;
wherein the processor is further caused to, prior to the generating the URL:
receive, via the NFC tag reader, transfer card data; and
send, to the transfer rail, the transfer card data,
wherein the URL further includes a unique device identifier, wherein the unique device identifier is of the computing device.

48. The computing device of claim 34, wherein the computing device is a contactless PIN entry on Commercial off-the-shelf (CPoC) device, a software-based PIN entry on Commercial off-the-shelf device (SPoC), or a mobile payments on commercial-off-the-shelf devices (MPoC) device.

49. The computing device of claim 34, wherein the sending the NDEF message includes sending the NDEF message to a user device; wherein the URL is accessible by the user device for the user device to display, in response to the accessing, a receipt of the transaction.

50. The computing device of claim 49, wherein the receipt is displayable through a web page corresponding to the address, without requiring input of personal information or an execution by the user device of an application, the personal information including an e-mail or a phone number.

51. A computing device comprising:
a communications module;
a processor; and
at least one memory coupled to the processor, and storing instructions which, when executed by the processor, cause the processor to:
receive transaction information corresponding to a transaction, the transaction including one or more purchases and a disbursement, the transaction information including a plurality of receipt elements;
determining that there is no Internet connectivity;
generate, as a consequence to determining that there is no Internet connectivity, a uniform resource locator (URL) which includes at least some of the plurality of receipt elements including a transactor name, a transaction date, an identification of the one or more purchases, or a total disbursement amount; and
send, via an NFC tag controller and to a user device, an NFC data exchange format (NDEF) message comprising the URL as a payload,
wherein the URL is formatted such that the user device is able to generate, by parsing the URL and without accessing the URL on the Internet, a receipt of the transaction.

52. The computing device of claim 51, wherein the processor is further caused to:
determine that there is the Internet connectivity;
send, via the communications module, to a server, the transaction information and the URL,
wherein the URL identifies a web resource corresponding to a second receipt of the transaction.

53. A computer-implemented method performed by a computing device, comprising:
receiving transaction information corresponding to a transaction, the transaction including one or more purchases and a disbursement, the transaction information including a plurality of receipt elements;
sending, to a transfer rail, the transaction information;
generating, using the transaction information: a unique transaction identifier;
generating a uniform resource locator (URL) which includes the unique transaction identifier;
receiving, from the transfer rail, a confirmation of a successful completion of a transfer card transaction corresponding to the transaction information; and
sending, to an NFC tag controller, an NFC data exchange format (NDEF) message comprising a string containing the URL as a payload,
wherein the computing device is a Payment Card Industry (PCI) certified payment device.

54. The computer-implemented method of claim 53, wherein prior to the sending, to the NFC tag controller, the URL, the method further comprises:
sending, to the NFC controller, the confirmation of the successful completion of the transfer card transaction corresponding to the transaction information.

55. The computer-implemented method of claim 53, wherein prior to the receiving the confirmation of the successful completion of the transfer card transaction corresponding to the transaction information, the method further comprises:
sending, to a server, the transaction information and the URL,
wherein the URL identifies a web resource corresponding to a receipt of the transaction.

56. The computing device of claim 53, wherein the URL identifies a web resource corresponding to a receipt of the transaction, wherein the web resource links to a web page or an app page for accessing by a user device of a receipt of the transaction.

57. The computer-implemented method of claim 53, wherein the unique transaction identifier is generated by using a hash function on the transaction information.

58. The computer-implemented method of claim 53, wherein the transaction information includes a unique identifier of the computing device, wherein the hash function is applied to the unique identifier, wherein prior to the sending, to the transfer rail, the transaction information, the method further comprises:
receiving transfer card data; and
sending, to the transfer rail, the transfer card data.

59. The computer-implemented method of claim 58, wherein the receiving of the transfer card data is received from a card reader (CR) device of the computing device, wherein the CR device comprises the NFC tag controller, wherein the unique device identifier is of the CR device.

60. The computer-implemented method of claim 53, wherein prior to the generating the URL, the method further comprises:
receiving, via an NFC tag reader, transfer card data; and
sending, to the transfer rail, the transfer card data.

61. A non-transitory computer readable medium containing instructions which, when executed by a processor of a computing device, cause the processor to:
receive transaction information corresponding to a transaction, the transaction including one or more purchases and a disbursement, the transaction information including a plurality of receipt elements;
send, to a transfer rail, the transaction information;
generate, using the transaction information: a unique transaction identifier;
generate a uniform resource locator (URL) which includes the unique transaction identifier;
receive, from the transfer rail, a confirmation of a successful completion of a transfer card transaction corresponding to the transaction information; and
send, to an NFC tag controller, an NFC data exchange format (NDEF) message comprising a string containing the URL as a payload,
wherein the computing device is a Payment Card Industry (PCI) certified payment device.
